(19) United States
(12) Patent Application Publication
(10) Pub. No.: US 2026/0336216 A1
(43) Pub. Date: Oct. 29, 2026

(54) METHODS AND SYSTEMS FOR FABRICATION WITH SELECTIVELY ENGAGEABLE CARRIER

(71) Applicant: Elastium, Inc., Los Angeles, CA (US)

(72) Inventor: Robert Karklinsh, Los Angeles, CA (US)

(21) Appl. No.: 19/658,236

(22) Filed: Apr. 24, 2026

Related U.S. Application Data
(60) Provisional application No. 63/794,029, filed on Apr. 24, 2025.

(51) Int. Cl. B29C 64/30; B29C 64/118; B29C 64/209; B29C 64/35; B33Y 30/00; B33Y 40/00

(52) U.S. Cl. CPC B29C 64/30; B29C 64/118; B29C 64/209; B29C 64/35; B33Y 30/00; B33Y 40/00

(57) ABSTRACT

Methods and Systems for Fabrication with Selectively Engageable Carrier are disclosed. A fabrication system may include a tool gantry movable along a first direction, the tool gantry being configured to carry a tool; a carrier movable along the first direction; and a coupling component configured to selectively couple the carrier to the tool gantry, the coupling component being operable during a fabrication operation to selectively engage and disengage the carrier from the tool gantry, in which: when the coupling component is engaged, the carrier is movable along the first direction by movement of the tool gantry, and when the coupling component is disengaged, the tool gantry is movable along the first direction without imparting motion along the first direction to the carrier.

### CROSS-REFERENCE TO RELATED APPLICATION(S)

This patent document claims priority to and the benefit of U.S. Provisional Application No. 63/794,029, filed on Apr. 24, 2025, the content of which is hereby incorporated by reference.

### TECHNICAL FIELD

The present disclosure generally relates to fabrication systems and methods, in particular fabrication systems and methods involving one or more tool gantries and one or more carriers.

### BACKGROUND

Fabrication systems are used to produce objects through various manufacturing processes, including additive, subtractive, and hybrid processes. Such systems typically include one or more tools configured to interact with a workpiece, and motion systems configured to position the tools relative to the workpiece during fabrication. There remains a continued interest in improving such fabrication systems.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended aspects, taken in conjunction with the accompanying drawings. Understanding that these drawings depict only several embodiments in accordance with the disclosure and are, therefore, not to be considered limiting of its scope, the disclosure will be described with additional specificity and detail through the use of the accompanying drawings.

FIG. 1 shows an isometric view of an exemplary 3D printing system according to some embodiments of the present technology.

FIG. 2 shows an isometric view of the 3D printer shown in FIG. 1, with portions removed to illustrate internal features, according to some embodiments of the present technology.

FIG. 3 shows yet another isometric view of the 3D printer shown in FIG. 1, with portions removed to illustrate internal features, according to some embodiments of the present technology.

FIGS. 4-5 show front views of the 3D printer shown in FIG. 1 in different operational states, with portions removed to illustrate internal features, according to some embodiments of the present technology.

FIG. 6 shows an isometric view of a tool gantry and a Y tray of exemplary disclosed 3D printers, connected by a coupling mechanism, according to some embodiments of the present technology.

FIG. 7 shows a side view of the tool gantry and the Y tray shown in FIG. 6 mounted on linear rails coupled to a portion of a 3D printer frame, according to some embodiments of the present technology.

FIG. 8 shows a partial bottom view of the tool gantry and the Y tray shown in FIG. 6 mounted on linear rails coupled to a portion of a 3D printer frame, according to some embodiments of the present technology.

FIG. 9 shows a front view of another exemplary embodiment of a 3D printer with portions removed to illustrate internal features, according to some embodiments of the present technology.

FIGS. 10A–10D show partial isometric sectional views of an exemplary embodiment of a 3D printer, with portions removed to illustrate internal features in different operational states, illustrating selected operations of methods shown in FIGS. 16-17, according to some embodiments of the present technology.

FIG. 11 shows a partial isometric sectional view of an exemplary embodiment of a 3D printer with portions removed to illustrate internal features, according to some embodiments of the present technology.

FIG. 12A shows a front sectional view of an exemplary embodiment of a 3D printer with portions removed to illustrate internal features, according to some embodiments of the present technology.

FIGS. 12B-12E show partial broken front sectional views of the 3D printer shown in FIG. 12A, with portions removed to illustrate internal features in different operational states, according to some embodiments of the present technology.

FIG. 13A shows a partial side sectional view of a tool gantry and a Y tray of exemplary disclosed 3D printers, connected by a coupling mechanism and mounted on linear rails coupled to a portion of a 3D printer frame, and further including an auxiliary coupling mechanism, according to some embodiments of the present technology.

FIG. 13B shows a partial front sectional view of the tool gantry and the Y tray shown in FIG. 13A, connected by the coupling mechanism shown in FIG. 13A and mounted on linear rails coupled to a portion of a 3D printer frame, and further including the auxiliary coupling mechanism shown in FIG. 13A, and additionally connected to a Y insulator, according to some embodiments of the present technology.

FIG. 14A shows a partial side sectional view of a tool gantry and a Y tray of exemplary disclosed 3D printers, connected by a coupling mechanism and mounted on linear rails coupled to a portion of a 3D printer frame, and further including an auxiliary coupling mechanism, according to some embodiments of the present technology.

FIG. 14B shows a partial front sectional view of the tool gantry and the Y tray shown in FIG. 14A, connected by the coupling mechanism shown in FIG. 14A and mounted on linear rails coupled to a portion of a 3D printer frame, and further including the auxiliary coupling mechanism shown in FIG. 14A, and additionally connected to a Y insulator, according to some embodiments of the present technology.

FIG. 15A shows a partial isometric sectional view of a tool gantry with a tool carriage including an active X tray coupling mechanism, shown together with a Y tray and an X tray, according to one set of embodiments, in a configuration prior to engagement of the X tray, according to some embodiments of the present technology.

FIG. 15B is a partial front sectional view of the tool gantry, the Y tray, and the X tray shown in FIG. 15A, mounted on linear rails coupled to a portion of the 3D printer frame, and further connected to a Y insulator, in a configuration following engagement of the X tray, according to some embodiments of the present technology.

FIG. 16 shows a block diagram illustrating a fabrication method, according to some embodiments of the present technology.

FIG. 17 shows another block diagram illustrating a fabrication method, according to some embodiments of the present technology.

FIG. 18 shows another block diagram illustrating a fabrication method, according to some embodiments of the present technology.

FIG. 19 shows another block diagram illustrating a fabrication method, according to some embodiments of the present technology.

FIG. 20 shows an isometric view of another exemplary embodiment of a 3D printer with portions removed to illustrate internal features, according to some embodiments of the present technology.

### DETAILED DESCRIPTION

It is contemplated that any embodiment discussed in this specification can be implemented with respect to any system of the technology, and vice versa. It will be also understood that particular embodiments described herein are shown by way of illustration and not as limitations of the technology. The principal features of this technology can be employed in various embodiments without departing from the scope of the technology. Those skilled in the art will recognize, or be able to ascertain using no more than routine experimentation, numerous equivalents to the specific procedures described herein. Such equivalents are considered to be within the scope of this disclosure and are covered by the aspects.

All publications and patent applications mentioned in the specification are indicative of the level of skill of those skilled in the art to which this technology pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no aspects included in the documents are incorporated by reference herein, and any definitions provided in the documents are not incorporated by reference herein unless expressly included herein.

References to items in the singular should be understood to include items in the plural, and vice versa, unless explicitly stated otherwise or clear from the text. The use of the term "or" in the aspects is used to mean "and/or" unless explicitly indicated to refer to alternatives only or the alternatives are mutually exclusive, although the disclosure supports a definition that refers to only alternatives and "and/or." Throughout this application, the term "about" is used to indicate that a value includes the inherent variation of error for the device, the method being employed to determine the value, or the variation that exists among the study subjects.

As used in this specification and aspect(s), the words "comprising" (and any form of comprising, such as "comprise" and "comprises"), "having" (and any form of having, such as "have" and "has"), "including" (and any form of including, such as "includes" and "include"), "containing" (and any form of containing, such as "contains" and "contain") or "constituting" (and any form of constituting, such as "constitutes" and "constitute") are inclusive or open-ended and do not exclude additional, unrecited elements or method steps. In embodiments of any of the compositions and methods provided herein, "comprising" may be replaced with "consisting essentially of" or "consisting of." As used herein, the phrase "consisting essentially of" requires the specified integer(s) or steps as well as those that do not materially affect the character or function of some embodiments of the present technology. As used herein, the term "consisting" is used to indicate the presence of the recited integer (e.g., a feature, an element, a characteristic, a property, a method/process step or a limitation) or group of integers (e.g., feature(s), element(s), characteristic(s), property(s), method/process steps or limitation(s)) only. As used herein, the word "portion" refers to any part, subset, segment, phase, or division of a whole, and may encompass the entirety of that whole unless explicitly stated otherwise.

The term "and combinations thereof" as used herein refers to all permutations and combinations of the listed items preceding the term. For example, "A, B, C, and combinations thereof" is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

The words "about," "approximately" or the like, when accompanying a numerical value, are to be construed as indicating a deviation as would be appreciated by one of ordinary skill in the art to operate satisfactorily for an intended purpose. In general, but subject to the preceding discussion, a numerical value herein that is modified by a word of approximation such as "about" may vary from the stated value by at least ±1, 2, 3, 4, 5, 6, 7, 10, 12, 15, 20 or 25%. Similarly, words of approximation such as "approximately" or "substantially" when used in reference to physical characteristics, should be understood to contemplate a range of deviations that would be appreciated by one of ordinary skill in the art to operate satisfactorily for a corresponding use, function, purpose or the like.

The term "transverse" and its derivatives are used herein with respect to some direction or object to refer to intersecting said direction or object not necessarily at a right angle.

In this document, the terms "mounted for linear movement," "mounted for rotation," "mounted for movement along an axis" or the like, as used herein with respect to some object should be understood without precluding the possibility of movement of the object in other ways.

All of the devices and/or methods disclosed and claimed herein can be made and executed without undue experimentation in light of the present disclosure. While the devices and methods of this technology have been described in terms of preferred embodiments, it will be apparent to those of skill in the art that variations may be applied to the devices and/or methods and in the steps or in the sequence of steps of the method described herein without departing from the concept, spirit and scope of this disclosure. All such similar substitutes and modifications apparent to those skilled in the art are deemed to be within the spirit, scope and concept of the technology as defined by the appended aspects.

For purposes of clarity, references to "X," "Y," and "Z" axes throughout this disclosure are made with respect to a nominal Cartesian coordinate system, in which the Z-axis is typically understood to be vertical and the X and Y axes define a horizontal plane. These designations are made solely to aid in the understanding of spatial relationships and are not intended to be limiting. A person skilled in the art will recognize that the described systems and methods may be implemented in any orientation, including permutations or reassignment of the axes, or in coordinate systems that are non-Cartesian, non-orthogonal, or otherwise arbitrarily defined, without departing from the scope of the patent document.

As used herein, directional terms such as "above," "below," "top," "bottom," and similar expressions are provided for illustrative purposes and are made with reference to either the Z-axis of a nominal Cartesian coordinate system or the direction of layer-wise material deposition in a three-dimensional printing process. In conventional configurations, the Z-axis typically aligns with the direction of layer-wise material deposition. However, in certain embodiments—such as those employing non-planar, tilted, or rotational build surfaces, including in multi-axis (e.g., five-axis) additive manufacturing systems—there may be no singular or fixed build direction. In such cases, the foregoing directional terms shall be construed relative to either the Z-axis or the instantaneous direction of layer formation, as appropriate, and are not intended to impose any structural or spatial limitation on the technology.

The term "providing," such as for "providing a print head,” when recited in the claims, is not intended to require any particular delivery or receipt of the provided item. Rather, the term "providing" is merely used to recite items that will be referred to in subsequent elements of the claim(s), for purposes of clarity and ease of readability.

As used herein, the terms "fabrication system," "additive manufacturing system," "3D printer," and "3D printing system" refer broadly to any apparatus or system configured to fabricate parts, prototypes, components, or support structures through one or more manufacturing processes, including additive, subtractive, hybrid, or other manufacturing processes. The fabrication system may comprise a standalone unit or may function as a sub-system within a larger integrated production line or manufacturing facility. The fabrication system may be implemented within an enclosed environment (e.g., a thermally or atmospherically controlled enclosure) or in an open configuration. In certain embodiments, the fabrication system may incorporate additive manufacturing functionalities, subtractive manufacturing functionalities (e.g., milling, cutting), pick-and-place automation, laser-based processing (e.g., ablation, cutting, sintering), two-dimensional printing technologies, inspection or metrology operations, or the like, or any combination thereof. Accordingly, the terms "fabrication" and "3D printing" shall be construed to encompass any of the above-noted processes, either individually or in combination, unless expressly stated otherwise. The term "build volume" may refer to a volume within which a fabrication process takes place, including but not limited to additive manufacturing, subtractive manufacturing, hybrid manufacturing, or the like, or any combination thereof.

As used herein, the term "tool" broadly refers to any device operable within the 3D printing system, including, without limitation, material extrusion printheads (e.g., filament-fed extruders, pellet-fed extruders, melt blowing tools), material deposition devices, forming or shaping elements, rollers, cutters, localized heating devices (e.g., resistive or radiative heaters, lasers), localized cooling elements, fiber reinforcement applicators (e.g., carbon fiber deposition modules), sensing or monitoring units (e.g., optical imaging systems, cameras), and metrology instruments (e.g., laser rangefinders, contact or non-contact probes) configured to detect part geometry, dimensional properties, or surface features during or after fabrication. As used herein, the term "active tool" refers to a tool that is currently operatively engaged with the build process, i.e., a tool that is actively performing its intended function (e.g., depositing material, cutting, heating, or sensing) at a given time during operation.

An extrusion-based 3D printing system with an insulated chamber may introduce a printhead into the chamber through an insulator tray that is permanently coupled to the tool gantry, moving together with it at all times.

This arrangement may restrict the travel limits of the tool gantry to the limits imposed by the insulator tray, which may be primarily determined by the closed length of an insulator, such as the compressed length of deformable insulator or the diameter of a rollable insulator drum. These constraints may significantly limit the build volume, particularly in systems employing multiple tool gantries.

A further limitation arises in systems with a tool changer, where printheads need to be parked above the movable insulator, resulting in a tool axis with excessive vertical travel. Such limitations may be problematic for pellet-based printheads, which often include extended extruder barrels. For some pellet-based systems, this configuration may become impractical, as such systems often benefit from having additional vertical clearance below the parking area for incorporating purging stations.

Furthermore, hybrid additive manufacturing systems—such as those described herein—benefit from insulator trays having a portion (e.g., a fan duct or dust shoe) that is positioned within the insulated chamber during operation but are also configured to be moved outside of the chamber when not in use. Such capability is not enabled by the prior art. In addition, these hybrid systems may incorporate tools such as pick-and-place grippers to introduce relatively large objects into the build chamber—functionality that is not feasible in known systems, which typically allow tool access only through a narrow opening in the insulator tray.

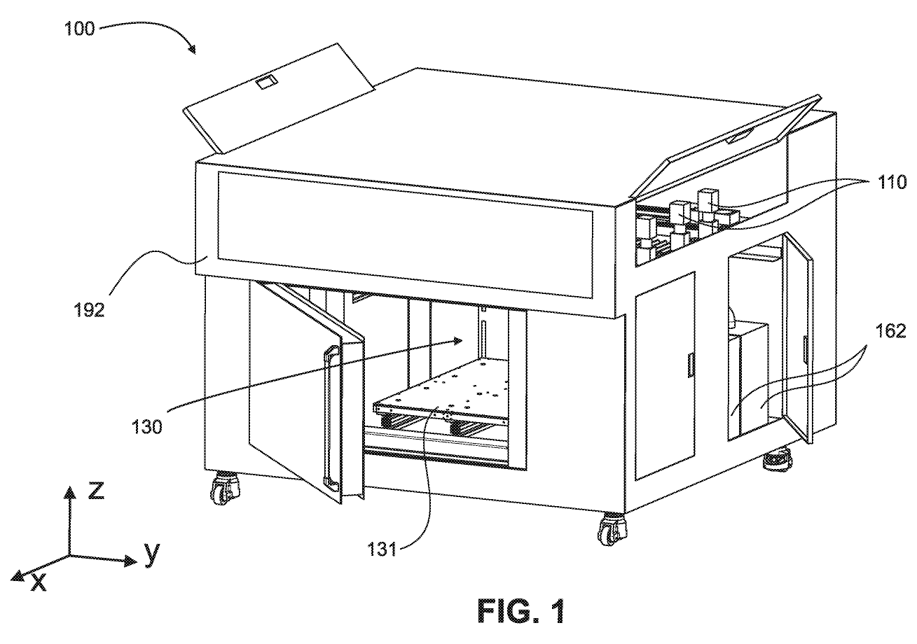

To address these and other technical challenges, a 3D printer (or another type of fabrication system) of the present disclosure includes a build surface 131 on which a material is to be deposited during a fabrication operation or a surface at which a tool interacts with a workpiece. In some embodiments, such as those shown in FIGS. 1-5, the build surface 131 may be a substantially planar build surface (e.g., a substantially flat surface of a build plate of the fabrication system) that lies substantially in a plane defined by the X direction and the Y direction, or in a plane defined by a first direction and a second direction, the second direction being transverse or non-parallel to the first direction. For example, the Y direction may correspond to a first direction along which the tool gantry 101 is movable, and the X direction may correspond to a second direction along which the tool carriage 102 is movable relative to the tool gantry 101, the second direction being transverse to the first direction.

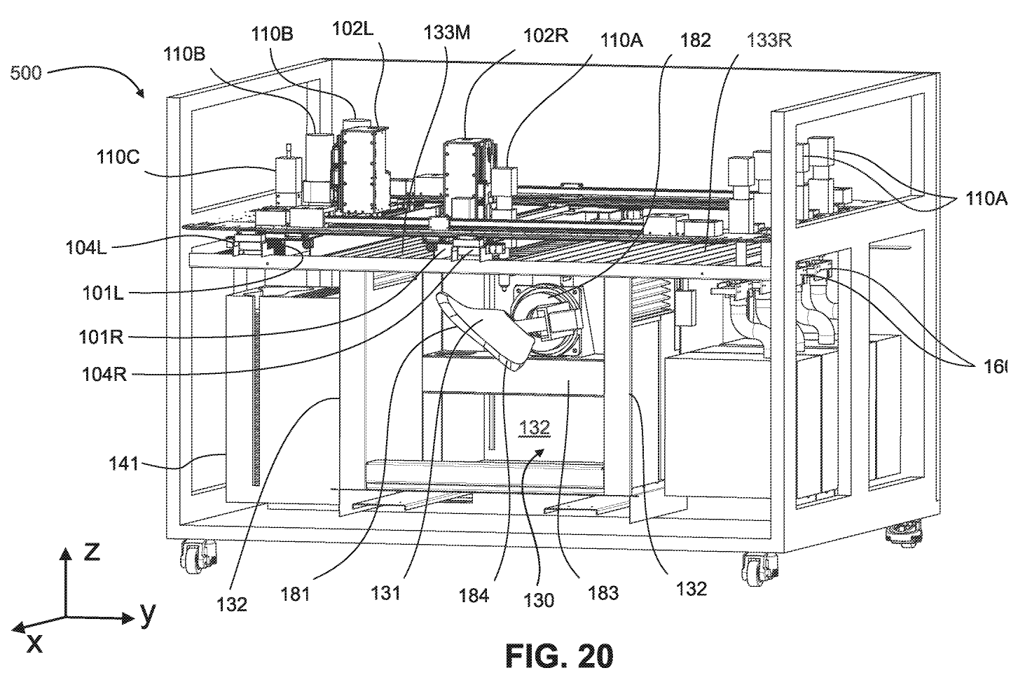

In some embodiments, the build surface 131 is a substantially non-planar build surface. For example, the build surface 131 may be a substantially curved surface, such as a surface of a shoe last–shaped substrate placed inside the 3D printer, as shown in FIG. 20. A non-planar build surface 131 may extend along the Z direction in addition to the X and Y directions, or along a third direction transverse or non-parallel to the first and second directions. For example, the first direction may refer to a direction along which the tool gantry 101 is movable, and the second direction may refer to a direction along which the tool carriage 102 is movable relative to the tool gantry 101, the second direction being transverse or non-parallel to the first direction, regardless of the orientation or geometry of the build surface 131.

In some embodiments, the build surface 131 may be tilted or rotated during fabrication, such that the orientation of the build surface 131 relative to the first direction and the second direction may vary during the fabrication operation. For example, the first direction and the second direction may be defined by the directions of motion of the tool gantry 101 and the tool carriage 102, respectively.

The 3D printer may further include a positioning system configured to position a tool relative to the build surface. A variety of positioning systems are known in the art and suitable for use as the positioning system. For example, the positioning system may include a Cartesian coordinate positioning system or X-Y-Z positioning system employing a number of linear controls to move independently in the X-axis, the Y-axis, and the Z-axis. Alternatively, or in addition, Delta positioning systems may be usefully employed. Alternatively, yet, or in addition, robotic manipulators may be usefully employed. More generally, any positioning system suitable for controlled positioning of the tool relative to the build surface may be usefully employed. For example, the tool may be operably coupled to the positioning system such that the positioning system positions the tool. The build surface may also, or instead, be operably coupled to the positioning system such that the positioning system positions the build surface. Some other combinations of these techniques may be employed, such as by moving the tool up and down for Z-axis control, and moving the build surface within the X-Y plane to provide X-axis and Y-axis control. In some implementations, the positioning system may translate the build surface along one or more axes, and/or may rotate the build surface. The positioning system may include a number of electric motors to independently control the position of the tool or the build surface along each axis, e.g., an X-axis, a Y-axis, and a Z-axis. More generally, the positioning system may include various combinations of stepper motors, linear motors, servo motors, gears, belts, pulleys, worm gears, threads, and the like. Any such arrangement suitable for controllably positioning the tool or the build surface may be adapted to use with the 3D printing system.

The 3D printer further includes a control system. The 3D printer may further include a communication link that links the control system with a tool to establish communication between the control system and the tool. The 3D printer may further include a communication link that links the control system with the positioning system to establish communication between the control system and the positioning system. The control system may be configured to control the extrusion and the relative motion of the tool relative to the build surface to fabricate the object on the build surface by sequentially depositing a plurality of layers of the deposition material, wherein the deposition of a layer of the deposition material includes extruding the deposition material towards a deposition surface while moving the tool relative to the build surface to deposit the deposition material on the deposition surface. The control system may execute instructions generated based on a three-dimensional model or any other digital representation of the object, the instructions defining the 3D printing process. The instructions may be generated externally and input to the control system. Alternatively, or in addition, the instructions may be generated by the control system itself. For example, instructions may define the movement path of the tool relative to the build surface, further referred as tool path. The tool path may be predefined. Alternatively, or in addition, a portion of the tool path may be generated and/or adjusted dynamically during the 3D printing process. The control system may be a distributed system including a plurality of subsystems. For example, the control system may comprise a cloud-based subsystem, which may be configured to generate high-level instructions based on a three-dimensional model of the object. The control system may further comprise a path planning subsystem connected to the cloud-based system over a wired or wireless interface, the path planning subsystem may interpret the high-level instructions received from the cloud-based system by generating low-level instructions corresponding to the tool path for motors of the positioning system and transfer them to the positioning system over the communication link. The control system may be implemented using one or more controllers, mounted statically or for movement, interconnected over wired or wireless communication links.

During the three-dimensional printing process, if the deposition material is deposited on the build surface (for example, the currently deposited layer is the first from the build surface), the term "deposition surface" refers to the build surface. Otherwise, the term "deposition surface" refers to a surface of a previously deposited deposition material. For example, during the deposition of a layer of a deposition material, a deposition surface may be formed by a surface of a previously deposited layer of the deposition material. As another example, a first tool may deposit a first deposition material onto a deposition surface formed by a second deposition material earlier deposited by a second tool.

In one aspect, the present disclosure is directed to 3D printers and 3D printing methods that employ one or more tool gantries 101 configured to move, without limitation, along a Y direction (e.g., first direction). The tool gantries 101 may be operably coupled to one or more tool carriages 102 carrying one or more tools 110. Each tool carriage 102 may be configured to move, without limitation, along an X direction (e.g., second direction) relative to the corresponding tool gantry 101, such that the one or more tools 110 are movable along the X and Y direction, and optionally along one or more additional directions, such as a Z direction (e.g., third direction), by motion of the tool carriage 102.

For purposes of clarity and consistency throughout this disclosure, references to components identified with base reference numerals—such as tool gantry 101, tool carriage 102, tool 110, Y tray 104, coupling mechanism 105, auxiliary coupling mechanism 106, and Y insulator 133—are intended to be construed broadly as encompassing corresponding variants identified by suffixes, including but not limited to 101L, 101R, 102L, 102R, 104L, 104R, 105L, 105R, 106L, 106R, 110A, 110B, 110C, 133L, 133M, and 133R unless the context explicitly indicates otherwise.

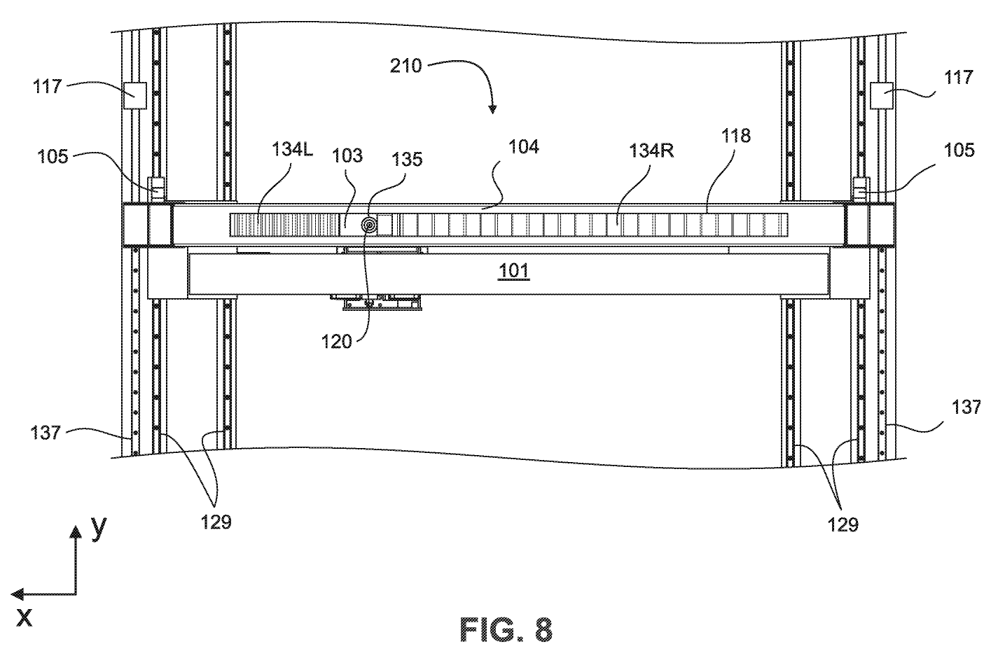

For illustration purposes and not intended to be limiting, FIGS. 1-5, 11, 12A-12E and 20 illustrate different embodiments of a fabrication system, which in the illustrated embodiments is implemented as a 3D printer of the present disclosure. The illustrated embodiments include a pair of tool gantries 101L and 101R configured for positioning along the Y direction, the first tool gantry 101L operably coupled to a first tool carriage 102L configured for positioning along the X direction relative to the tool gantry 101L, and the second tool gantry 101R operably coupled to a second tool carriage 102R configured for positioning along the X direction relative to the tool gantry 101R. FIG. 9 illustrates a 3D printer 200 according to another set of embodiments, including a single tool gantry 101 configured for positioning along the Y direction and operably coupled the tool carriage 102 configured for positioning along the X direction relative to the tool gantry 101. In other embodiments, three, four, or any suitable number of tool gantries 101 may be employed, depending on system configuration and application requirements. The term "fabrication system" as used herein is intended to be construed broadly to encompass any system configured to manufacture objects through additive, subtractive, hybrid, or other manufacturing processes, and is not limited to 3D printing systems.

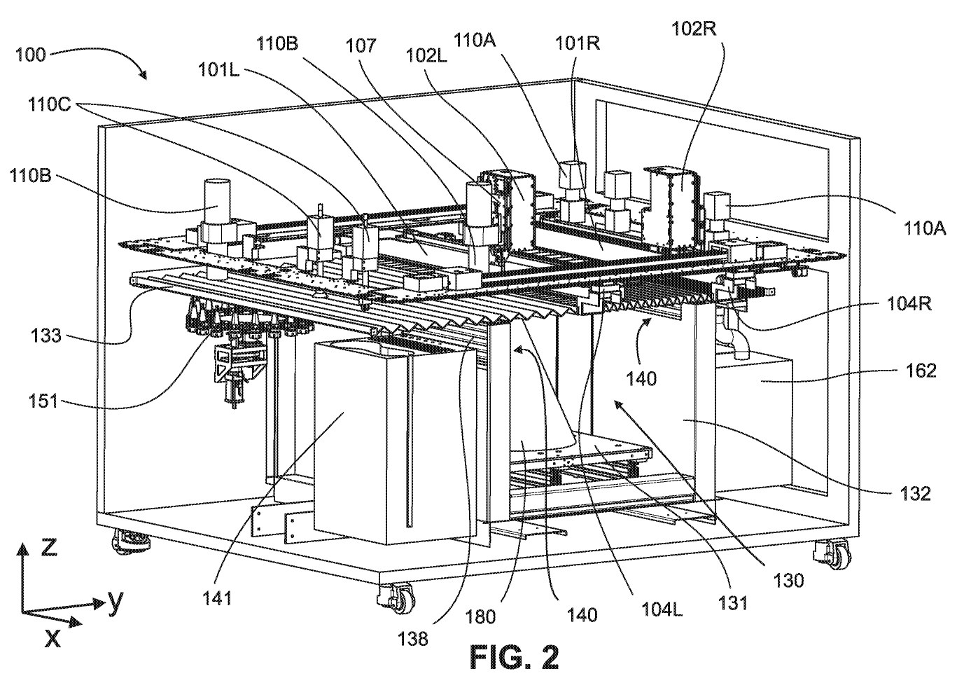

FIG. 1 is a perspective view of the 3D printer 100 enclosed in cabinets 192. FIGS. 2-5 are perspective and side views of the 3D printer 100 with portions removed to illustrate internal features more clearly. The 3D printer 100 includes eight tools: four tools are printheads 110A that are carried by the second tool gantry 101R, two tools are pick and place grippers 110C that are carried by the first tool gantry 101L, and two tools are subtractive tools 110B that are carried by the first tool gantry 101L. FIG. 9 illustrates a 3D printer 200 according to another set of embodiments, with portions removed to illustrate internal features more clearly, including two tools 110 carried by the tool gantry 101.

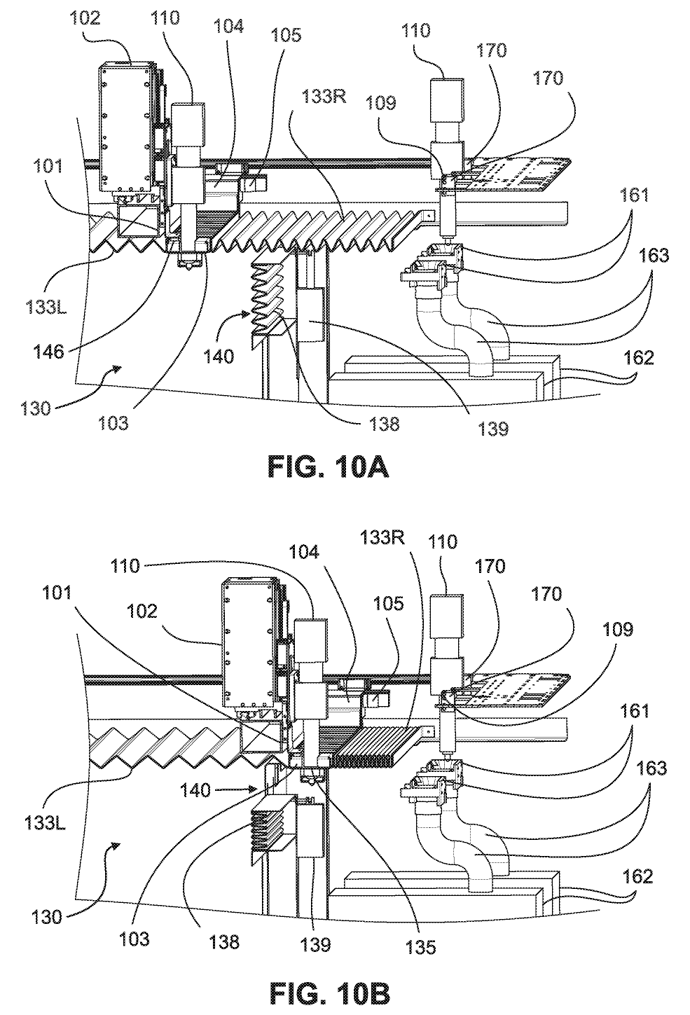

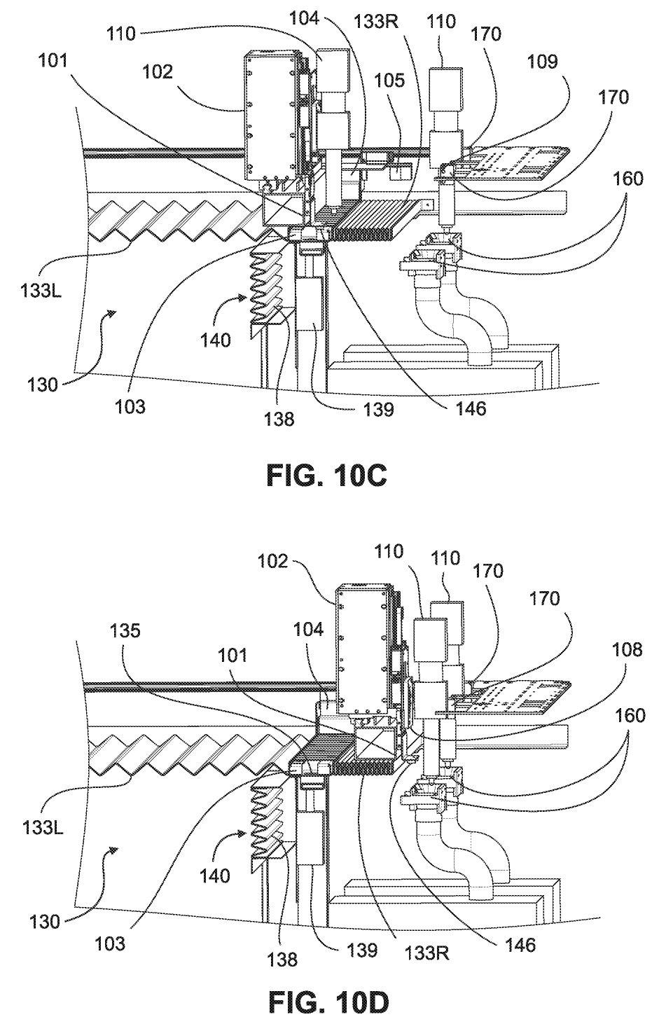

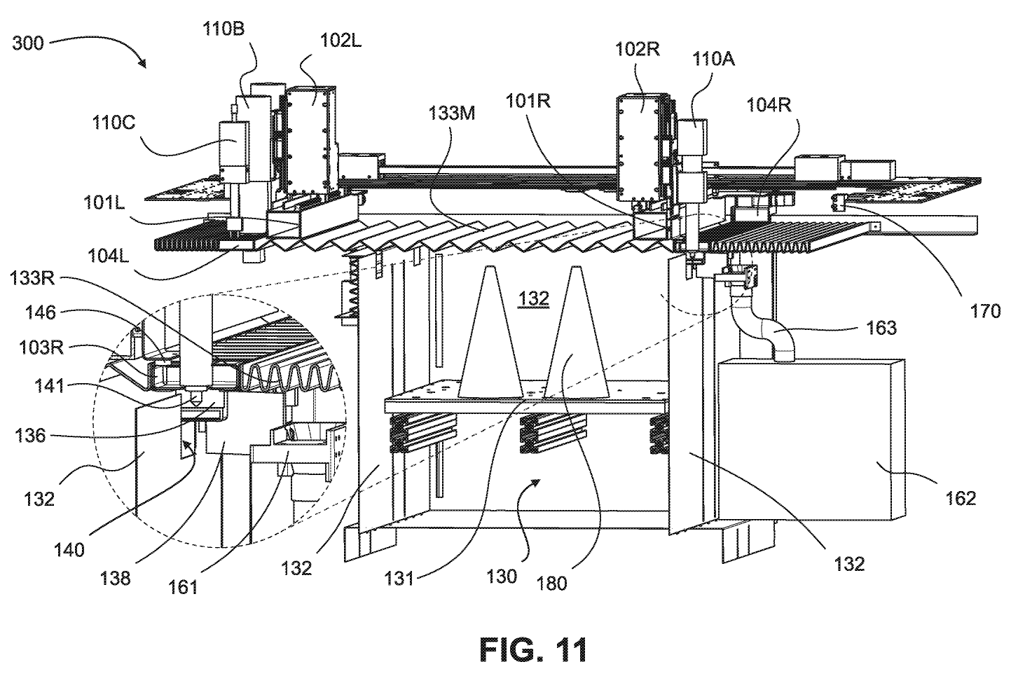

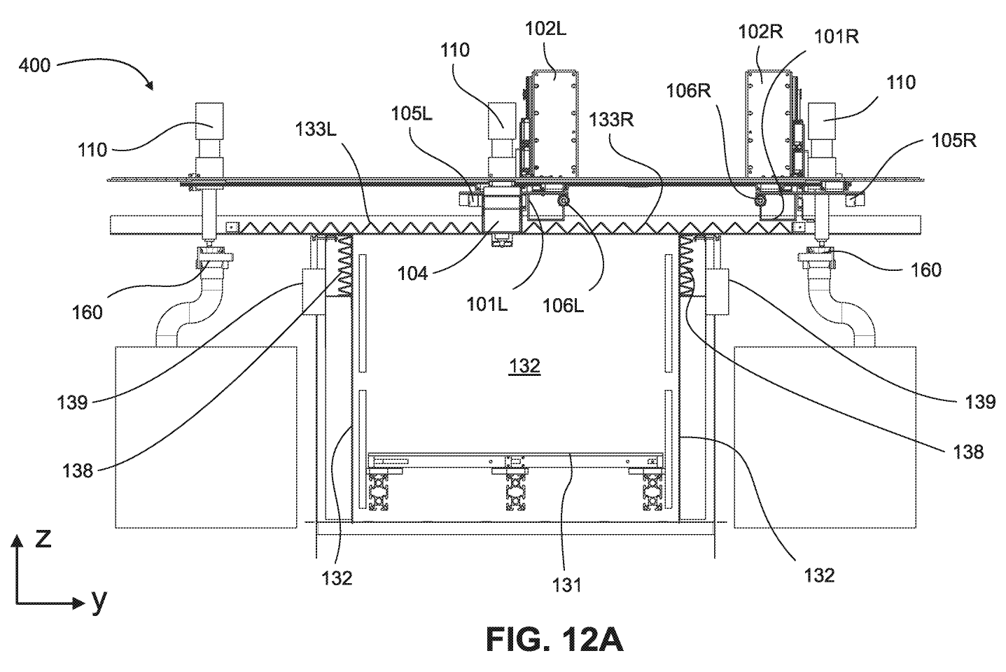

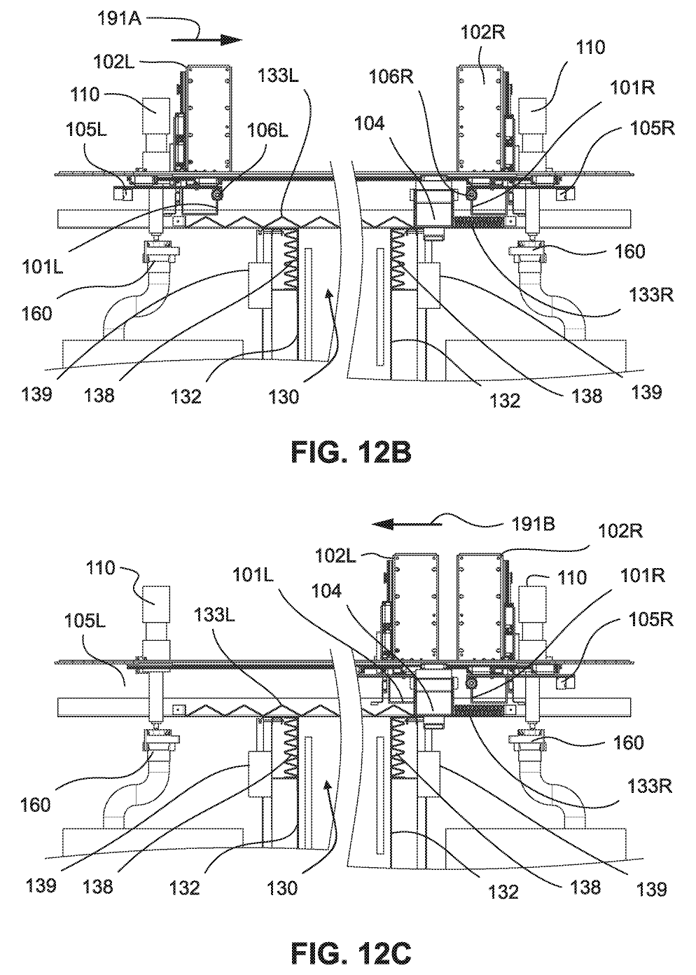

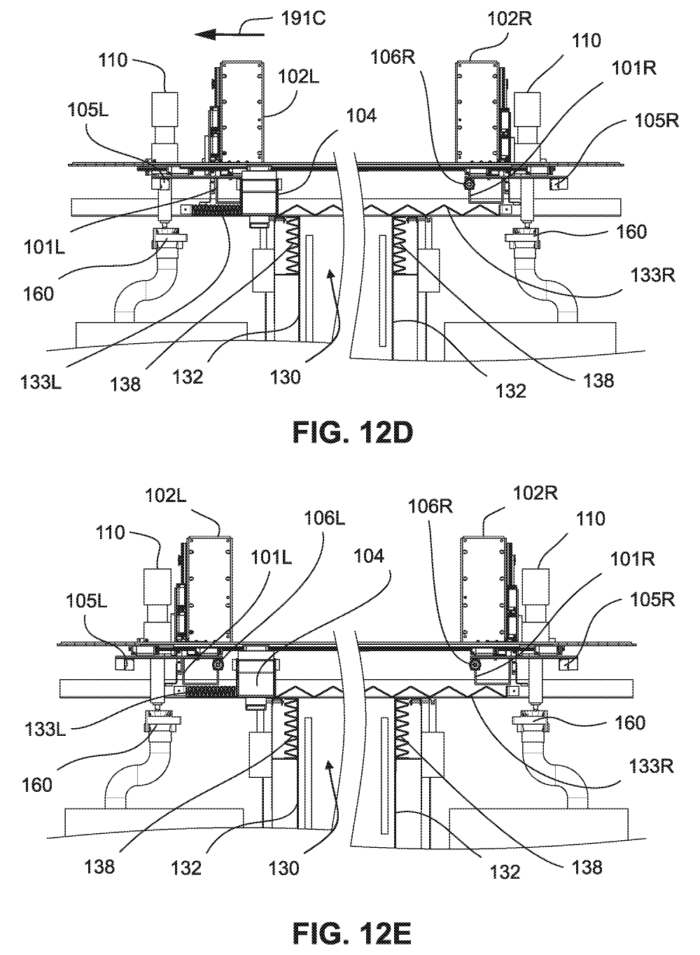

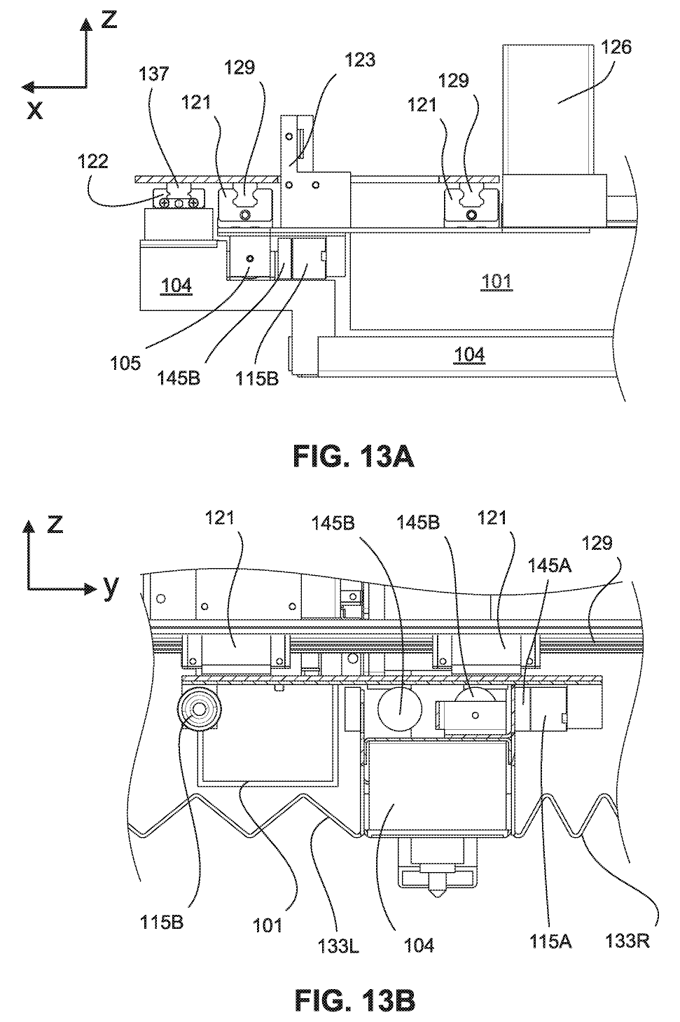

FIG. 11 illustrates a 3D printer 300 according to another set of embodiments, with portions removed to illustrate internal features more clearly, including a plurality of tools, such as a printhead 110A, a subtractive tool 110B and a pick and place gripper 110C. FIGS. 12A-12E illustrate a 3D printer 400 according to yet another set of embodiments, with portions removed to illustrate internal features more clearly, including eight printheads 110A, with the four printheads 110A carried by the first gantry 101L and the four printheads 110A carried by the second gantry 101R. FIG. 20 illustrates a 3D printer 500 according to yet another set of embodiments, with portions removed to illustrate internal features more clearly, including a pair of tool gantries 101L and 101R, the tool gantry 101R configured to carry a plurality of printheads 110A, and the tool gantry 101L configured to carry a plurality of application-specific tools, such as subtractive tools 110B, pick and place grippers 110C, and the like. As illustrated in FIG. 12A, the 3D printer 400 includes a carrier (implemented as a Y tray 104) shared between the first tool gantry 101L and the second tool gantry 101R. The 3D printer 400 further includes a first primary coupling mechanism 105L and a first auxiliary coupling mechanism 106L associated with the first tool gantry 101L, and a second primary coupling mechanism 105R and a second auxiliary coupling mechanism 106R associated with the second tool gantry 101R, each of the first and second primary coupling mechanisms 105L, 105R and first and second auxiliary coupling mechanisms 106L, 106R being operable to selectively engage the shared Y tray 104 to the respective tool gantry. Such dual-gantry configurations with a shared carrier are described elsewhere in the present disclosure, e.g., with reference to FIGS. 12A–12E and the associated coupling mechanisms shown in FIGS. 13A–14B.

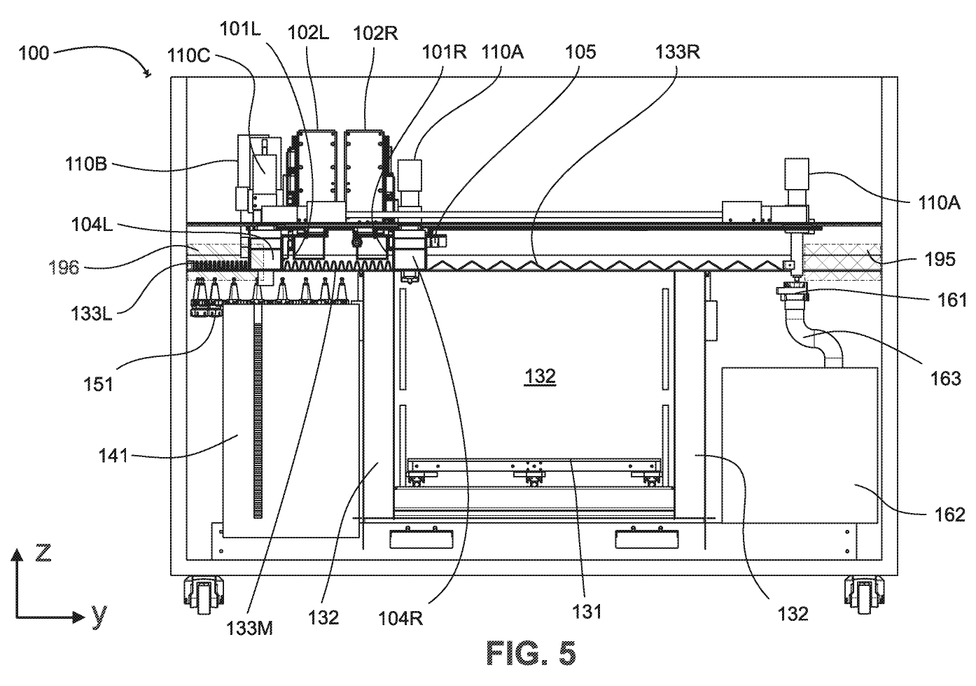

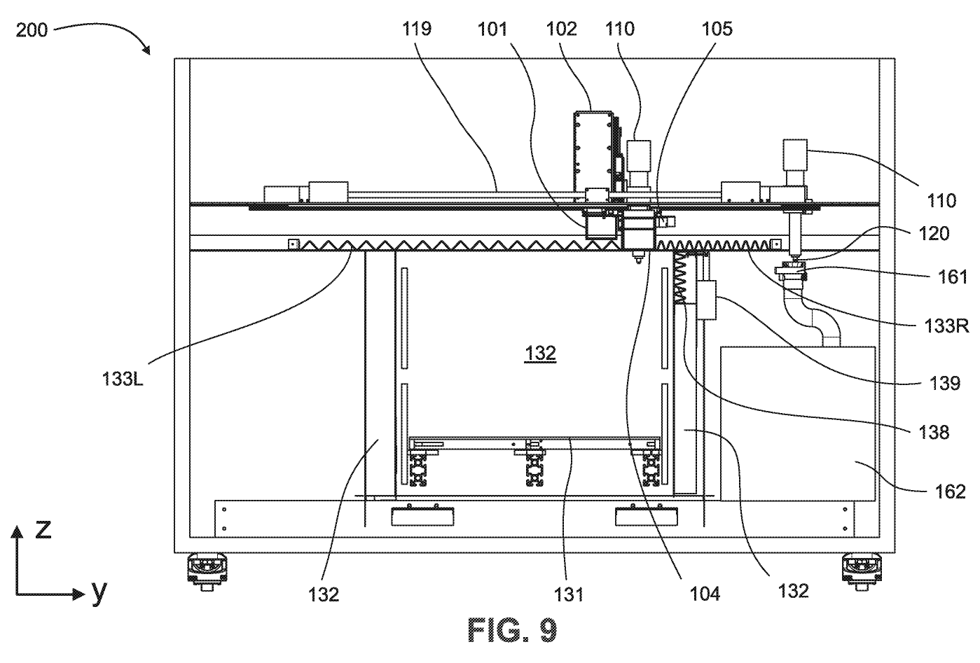

The tool carriage 102 may include a tool mount 108 for receiving and retaining tools 110. The tool carriage 102 may include an additional linear axis, further referred to as a tool axis 107, configured to move the tool mount 108 with retained tool along the Z direction. The tool axis 107 may employ a belt drive 127 for positioning along the Z direction, as shown in FIG. 6. In embodiments, the tool axis 107 may employ various combinations of a belt drive, a linear motor, a piezo actuator, a voice coil, a lead screw, a ball screw, a rack and pinion actuator, and the like, suitable for positioning the tool mount 108 along the Z direction. In embodiments where a plurality of tools 110 are configured to be carried by the tool gantry 101, a 3D printer (or another fabrication system) of the present technology may include one or more parking stations 170, each configured to receive a tool 110 when not in active use. The parking station 170 may include a tool mount 109, best shown in FIGS. 10A-10C, for retaining the tool 110 when not in active use. In some embodiments, the parking station 170 may include an actuated locking mechanism or docking assist feature to secure or align the tool 110 when not in active use. In some embodiments, the parking station 170 is located at a position along the Y direction outside a footprint of the carrier (e.g., the Y tray 104) defined by the Y direction and the X direction, such that the tool gantry 101 is configured to receive the tool 110 at the parking station 170 by translating the tool gantry 101 along the Y direction to a position outside the footprint of the carrier while the coupling mechanism 105 is disengaged.

The 3D printers 100, 200, 300 and 400 include a substantially flat build surface 131 configured for positioning along Z direction. Instead, or in addition to positioning along the Z direction, the build surface 131 may be configured for tilting or rotating, required for non-planar 3D printing. For example, the build surface 131 may be supported by plurality of independently controlled linear positioning elements—such as two, three, or four—and coupled to them via a kinematic coupling. In such embodiments, the build surface 131 may be tilted by independently positioning the elements, thereby enabling controlled variation in the build surface 131 orientation during 3D printing. As another example, the build surface 131 may be supported by a multi-axis positioning system including linear positioning elements as well as rotary positioning elements. Without limitation, the build surface may be coupled to or be an integral part with dual-axis trunnion table, permitting rotation about two perpendicular axes. The build surface 131 may be further configured for positioning relative to the tool 110 along the Z direction by employing one or more linear positioning elements supporting the trunnion table. Instead, or in addition, the build surface 131 may be configured for positioning relative to the tool 110 in Z direction by the tool axis 107.

In other embodiments, the build surface 131 may be defined by a surface of an arbitrary substrate secured within the build volume and configured for positioning relative to one or more tools 110. For example, as shown in FIG. 20, the 3D printer 500 includes a shoe last–shaped substrate (hereinafter referred to simply as a last) 181, which defines the build surface 131. Alternatively, or in addition, a portion of the build surface 131 may be defined by a permanent embedded substrate, such as a textile upper disposed on the last 181, such that the embedded substrate becomes incorporated into the resulting part during 3D printing process. Alternatively, or in addition, a portion of the build surface 131 may be defined by a sacrificial embedded substrate, such as a layer of dissolvable material 184, as shown in FIG. 20, wherein the sacrificial embedded substrate is configured to be removed from the printed part during or after fabrication, for example by immersing the part in water.

As shown in FIG. 20, the last 181 may be mounted on a dual-axis rotary stage 182, which is configured to rotate the last about two perpendicular axes. The dual-axis rotary stage 182 may, in turn, be mounted on a platform 183 configured for linear positioning along the Z direction. Alternatively, or in addition, the tool axis 107 may be used for positioning along the Z direction. Such embodiments may be used for five-axis 3D printing, including deposition of material onto the build surface 131 with varying orientations, facilitating fabrication of complex, non-planar geometries.

In one aspect, the present disclosure is directed to fabrication systems including a carrier configured for linear movement along a direction, such as the Y direction. As used herein, the term “carrier” is to be construed broadly and may refer to any movable component configured to support, carry, or define one or more features associated with a fabrication operation, including but not limited to thermal insulators, partitions, fan ducts, dust shoes, sensors, localized heating or cooling elements, illumination elements, air curtains, material guides, umbilical supports, access features, or process-support devices. In some embodiments described below, the carrier is implemented as a Y tray 104. In some embodiments, the carrier may be implemented as any other structure configured to move along a direction and selectively couple to a tool gantry, without departing from the scope of the present disclosure. Accordingly, while the following description refers to a Y tray 104 for illustrative purposes, the principles described are applicable to carriers of various configurations.

In another aspect, the present disclosure is directed to fabrications systems (e.g., 3D printers) including an insulated chamber 130 (in this document also referred to as build chamber) within which an object 180 is formed. As used herein, the term "insulated chamber" generally refers to a volume bounded at least in part by one or more insulating structures 132, which may function to reduce heat loss and retain thermal energy within the chamber volume. In certain embodiments, the insulated chamber 130 may additionally or alternatively be configured for purposes unrelated to thermal regulation. For example, in embodiments incorporating subtractive manufacturing tools (e.g., milling or cutting implements), the insulated chamber may serve to isolate the motion system and associated components from particulate matter or debris generated during subtractive operations, thereby maintaining system cleanliness and operational integrity. Accordingly, references to an "insulated chamber" are not limited to heated enclosures unless explicitly stated, and may encompass a variety of functional configurations. In some implementations, the fabrication system may incorporate just a portion of the insulated chamber. For instance, the fabrication system may include a movable carrier or gantry-mounted subassembly carrying a dust collection shroud or debris containment feature (e.g., a dust shoe) configured to interface with subtractive tooling during operation.

The insulated chamber 130 may include a dynamic Y insulator 133 configured to vary its length or position along a Y direction. The insulated chamber 130 may also include a dynamic X insulator 134 configured to vary its length or position along an X direction. The Y and X insulators 133 and 134 may be deformable insulators, such as accordion pleated insulators, best shown in FIGS. 2-5 and 9-14. Alternatively, the Y and X insulators 133 and 134 may be rollable insulators. Alternatively, the Y and X insulators 133 and 134 may be telescopic insulators. The Y and X insulator 133 and 134 may be thermal insulators that allow the insulated chamber 130 to be maintained at elevated temperature while protecting temperature-sensitive components located outside the build chamber 130.

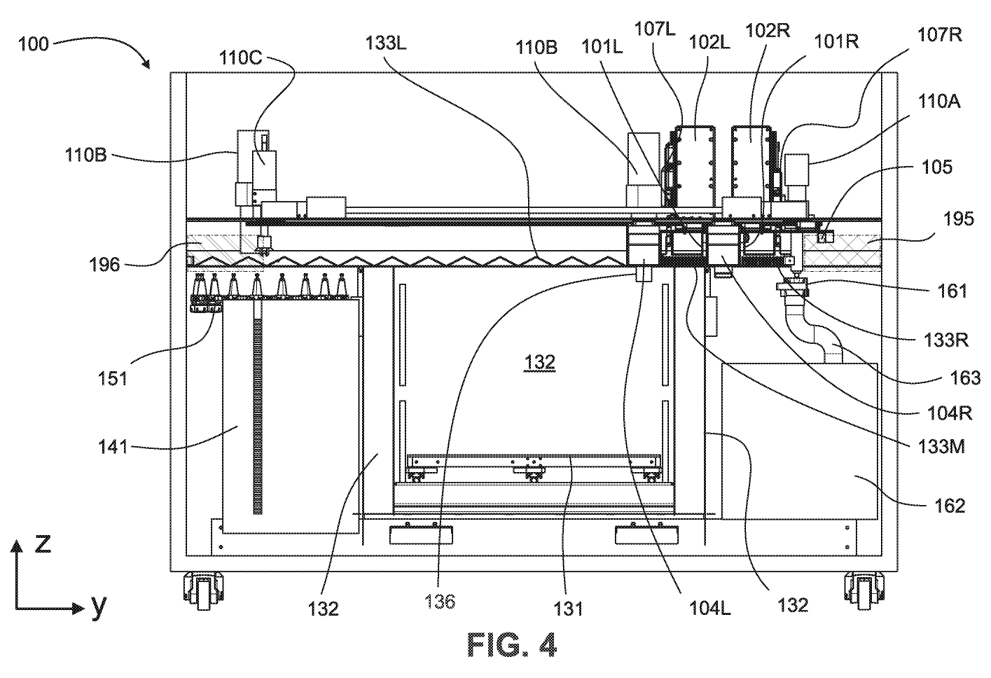

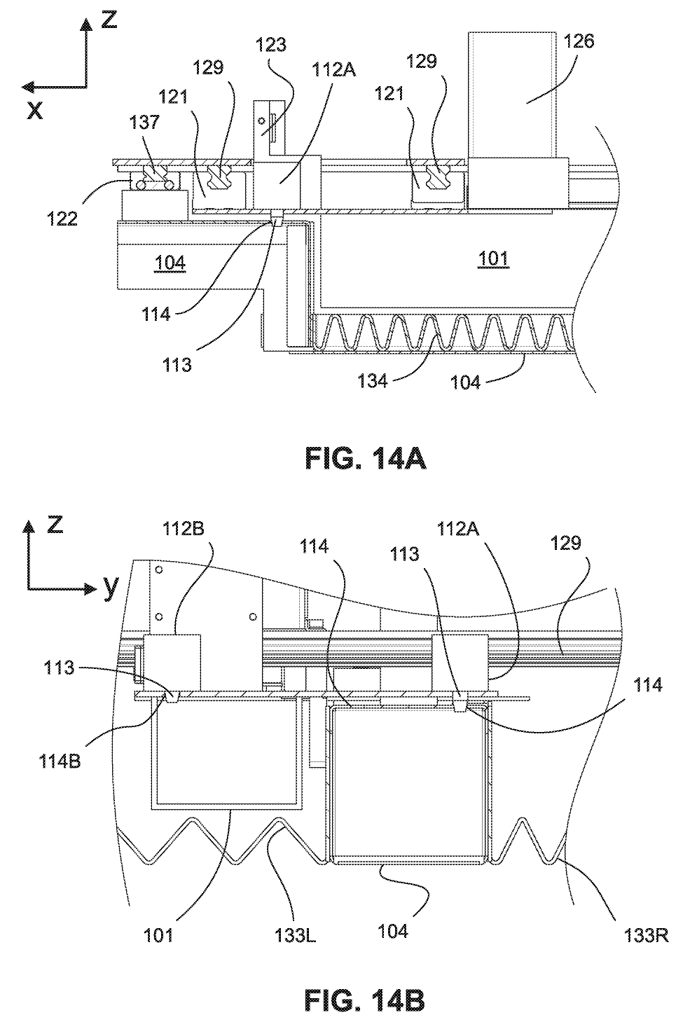

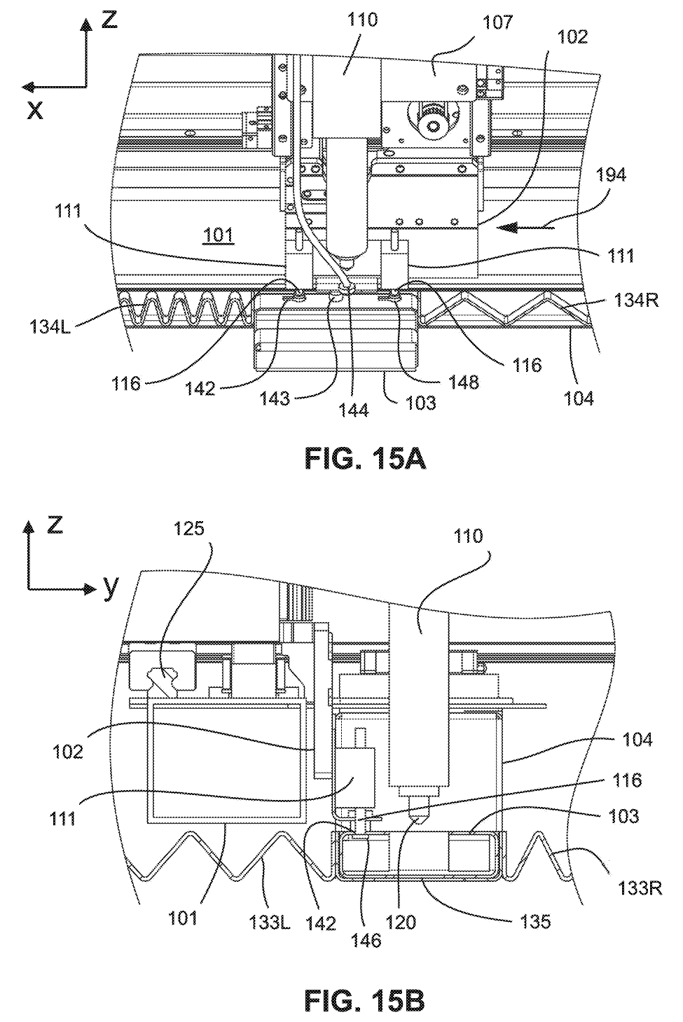

The 3D printer may further include a Y tray 104, which in some embodiments serves as a carrier as described elsewhere in the present disclosure, configured for linear movement along the Y direction. The Y tray 104 may be operably coupled to the Y insulator 133, such that when the Y tray 104 is moved along the Y direction, the Y insulator 133 changes its length or position along the Y direction. In some embodiments, for example, as shown in FIGS. 15A and 15B, the 3D printer may include a pair of Y insulators 133L and 133R coupled to opposing sides of the Y tray 104, such that when the Y tray 104 is moved in the Y direction, one Y insulator expands and the other contracts along the Y direction. In some embodiments, for example as shown in FIGS. 4-5, the 3D printer may include three Y insulators 133L, 133M, and 133R, wherein the middle Y insulator 133M is positioned between a first Y tray 104L and a second Y tray 104R, and is coupled to both. In such a configuration, when the Y trays 104L and 104R move toward each other along the Y direction, the Y insulator 133M contracts, and when the Y trays 104L and 104R move away from each other, the Y insulator 133M expands.

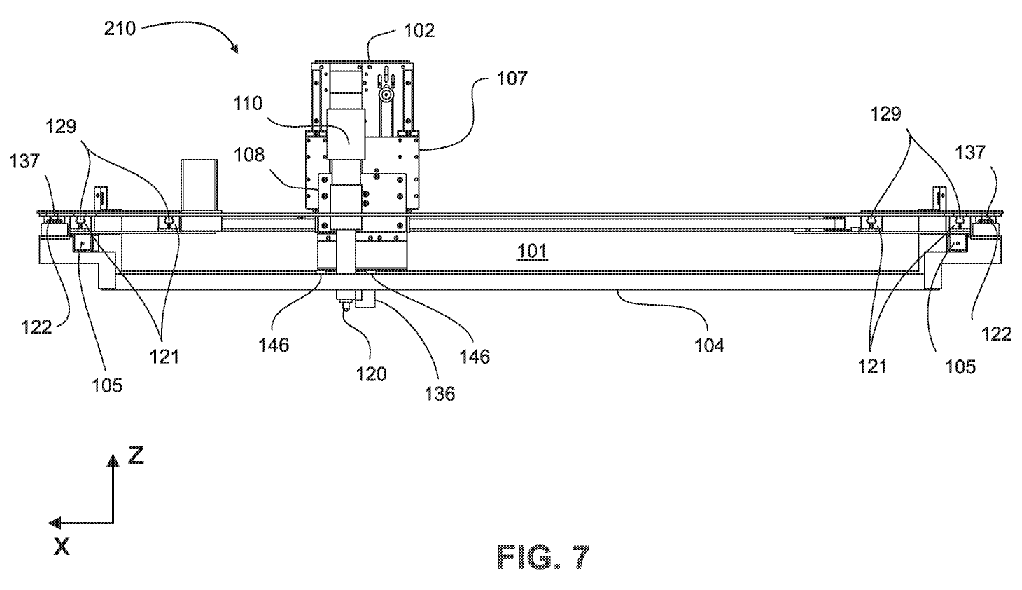

The 3D printer may further include a second carrier configured for linear movement along a second direction transverse to the first direction. In some embodiments, the second carrier is implemented as an X tray 103 configured for linear movement along the X direction relative to the Y tray 104. The X tray 103 may be operably coupled to a pair of X insulators 134L and 134R, best shown in FIGS. 6 and 8, such that when the X tray 103 is moved along the X direction, one X insulator contracts and the other expands. The Y tray 104 may further support the X insulators 134, such that the X insulators 134 are moved in the Y direction by the Y tray 104. The X tray 103 may be operably coupled to the tool carriage 102 and configured to move along the X direction by the tool carriage 102 relative to the Y tray 104.

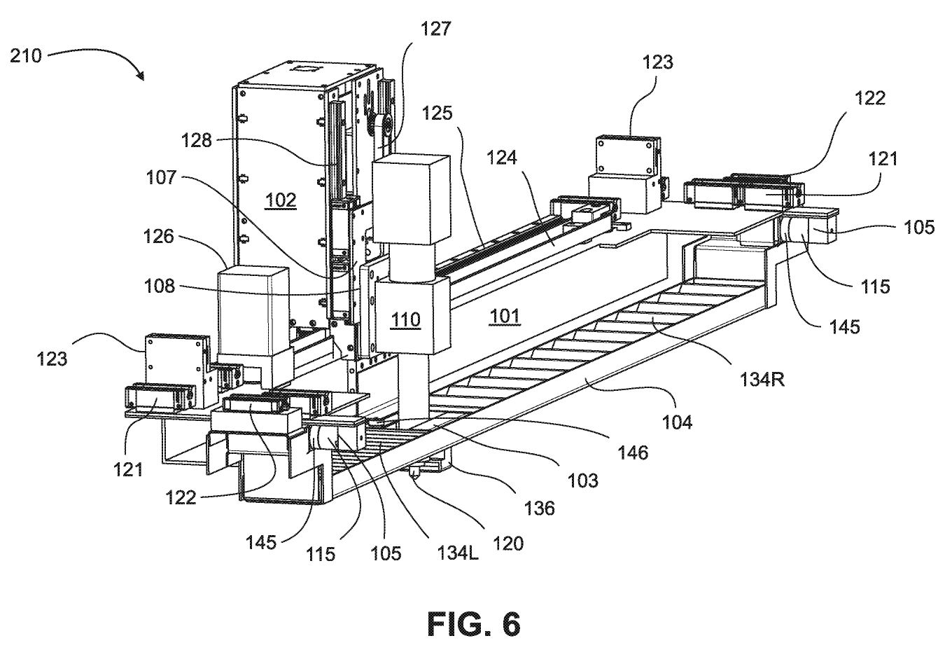

The X tray 103 may include a portion 136 extending downward, hereinafter referred to as the bottom extension 136. In some embodiments, as shown in FIGS. 6, 7 and 11, the bottom extension 136 may include a fan duct configured to direct airflow toward the printed object. In some embodiments—such as the bottom extension 136 of the Y tray 104L shown in FIG. 4—the bottom extension may include a dust shoe coupled to a vacuum pump via a hose and configured to remove debris from the build chamber 130 during or after subtractive operations of the 3D printing process.

The Y tray 104 may include an opening 118 extending along the X direction, as shown in FIG. 8, through which a tool 110 may access the build chamber 130 as it is moved along the X direction. Similarly, the X tray 103 may include an opening 135 for accommodating tool access to the build chamber 130, also illustrated in FIG. 8. These openings 118 and 135 in the Y tray 104 and X tray 103, respectively, are distinct from and may operate in conjunction with access windows 140 formed in the insulating structures 132 of the build chamber 130, as described elsewhere in the present disclosure. In alternative embodiments, rather than employing a movable X tray 103 and associated X insulators 134, the 3D printer may utilize a static insulator integrated within the Y tray 104, configured to provide tool access to the build chamber 130. For example, the Y tray 104 may define a slit or slot extending along the X direction, which may be insulated using a brush seal, elastic flap, or other flexible thermal barrier. This configuration allows the tool 110 to pass through the slit while maintaining insulation of the build chamber 130.

The Y tray 104 may further be mounted for linear movement along the Y direction via various combinations of linear guide mechanisms, such as linear rails, linear bearings, guide channels, and the like. In one set of embodiments (best shown in FIGS. 6-8), the Y tray 104 is attached to rail blocks 122 on each side of the Y tray 104 that are movably supported by linear rails 137. As another example, the Y tray 104 may be slidably mounted in a guide channel extending along the Y direction.

The Y tray 104 may be coupled to the tool gantry 101 through an active coupling mechanism 105 configured to selectively engage and disengage the Y tray 104 from the tool gantry 101, such that when the coupling mechanism 105 is engaged, the Y tray 104 is moved by the tool gantry 101 along the Y direction. In one set of embodiments, best shown in FIG. 6, the coupling mechanism 105 employs an electromagnet 115 mounted on the tool gantry 101 and facing a mating armature 145 on the Y tray 104 such that when the tool gantry 101 is moved toward the Y tray 104 along the Y direction from a parking position at its associated parking station 170, as shown in FIGS. 10A-10C (in reverse), the parking station 170 being located outside a footprint of the Y tray 104 defined by the Y direction and the X direction, the electromagnet 115 establishes contact with the mating armature 145, best shown in FIGS. 6, 10B and 13B. In another set of embodiments, best shown in FIGS. 14A-14B, the coupling mechanism 105 may employ a push solenoid 112 having a retractable pin 113 which engages the Y tray 104 when extended through an opening 114 in the Y tray 104 and disengages when retracted. In general, any suitable active coupling mechanism 105 may be used, including but not limited to mechanisms employing servo actuators, piezoelectric actuators, solenoids, electromagnets, pneumatics, hydraulics, or the like, provided that the mechanism is capable of withstanding accelerations of the tool gantry 101 during fabrication operations.

In another set of embodiments, the Y tray 104 may be coupled to the tool gantry 101 through a passive coupling mechanism 105, such as a permanent magnet or a mechanical latch. In this case, the engagement or disengagement may be controlled by the tool gantry 101. For example, the tool gantry 101 may be configured to disengage the Y tray 104 by moving it into contact with a pair of limiters 117, as shown in FIG. 8, to overcome the passive coupling force. Instead, or in addition to limiters 117, the engagement or disengagement of the passive coupling mechanism 105, may be controlled by a brake, such as linear rail break, mounted on the rail blocks 122 of the Y tray 104. For example, the Y tray 104 can be disengaged by moving the tool gantry 101 relative to the Y tray 104 along the Y direction after the break is activated.

In another set of embodiments, instead or in addition to being moved by the tool gantry 101, the Y tray 104 may be driven by a linear drive mechanism, which may include, for example, a belt drive, linear motor, ball screw, or the like. In such embodiments, the Y tray 104 may be configured to move synchronously with the tool gantry 101 when the gantry is carrying an active tool, and to move independently of the tool gantry 101 during periods when the coupling mechanism 105 is disengaged, such as during a tool change procedure, as described elsewhere in the present disclosure.

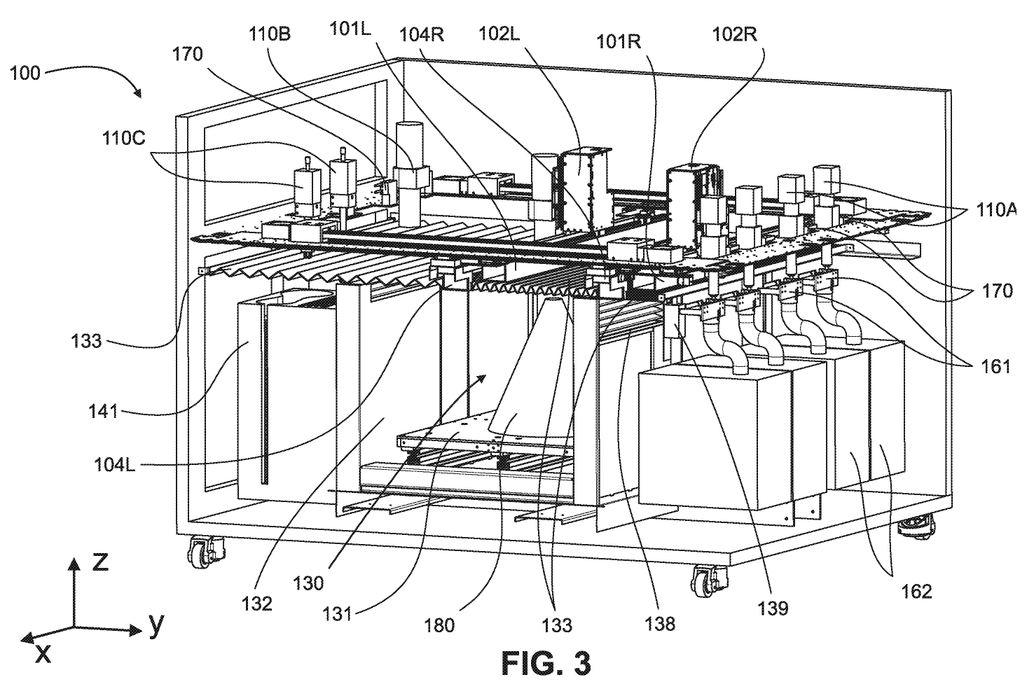

The tool gantry 101 and the Y tray 104 may be further arranged such that the tool gantry 101 is capable of passing above the Y tray 104 when the coupling mechanism 105 is disengaged, as best shown in FIGS. 3, 4, 6, and 10C-10D. In embodiments, the tool gantry 101 may be further configured to move above the dynamic insulators 134 or dynamic insulators 133, best shown in FIGS. 3, 4, 6, and 10C-10D. This arrangement enables the tool gantry 101 to translate along the Y direction to positions outside a footprint of the Y tray 104 defined by the Y direction and the X direction, including positions associated with parking stations 170, tool change stations, purging stations 160, and access windows 140 formed in the insulating structures 132 of the build chamber 130. Selective disengagement of the coupling mechanism 105 thus enables operational configurations and positioning of the tool gantry 101 that would not be available when the Y tray 104 is permanently coupled to the tool gantry 101.

In some embodiments, the second carrier (e.g., the X tray 103) is configured to selectively engage the tool carriage 102. For example, the X tray 103 may be engaged with the tool carriage 102 by lowering the tool 110 into an opening 135 defined by the X tray 103, thereby substantially preventing relative movement between the X tray 103 and the tool carriage 102, as best shown in FIGS. 10B, 10D, and 15B. Conversely, the X tray 103 may be disengaged from the tool carriage 102 by lifting the tool 110 out of the opening 135.

The X tray 103 may define multiple vertically spaced openings 135 along the Z direction, thereby reducing play during movement of the X tray 103 by the tool 110 along the X direction during the printing process. Alternatively, or in addition, the 3D printer may include elastic or spring-loaded members coupled to the X tray 103 and configured to assert pressure against the lowered tool 110 to provide preload and further reduce mechanical play. In some embodiments, the spring-loaded members may instead be coupled to the tool 110 and configured to assert pressure against the X tray 103 as the tool is lowered into the opening 135.

Alternatively, or in addition, the X tray 103 may be coupled to the tool carriage 102 through an X tray coupling mechanism. For example, as best shown in FIGS. 6, 7, 10C–10D, and 11, the X tray coupling mechanism may be a passive mechanism employing one or more permanent magnets 146 coupled to the tool carriage 102 and configured to attract the X tray 103.

In such embodiments, the X tray 103 may be disengaged from the tool carriage 102 by moving the tool gantry 101 relative to the Y tray 104 in the Y direction, as shown in FIGS. 10A–10D, wherein the Y tray 104 is configured to constrain the X tray 103 from moving in the Y direction relative to the Y tray, as best shown in FIG. 6. Alternatively, or in addition, the tool carriage 102 may disengage the X tray 103 by moving it into contact with a limiter along the X direction to overcome the passive coupling force. Without limitation, such limiter may be rigidly coupled to the Y tray 104 or tool gantry 101 to provide a relative motion between the X tray 103 and the tool carriage 102 along the X direction. The permanent magnets 146 may be located above the Y insulator 133, thereby configured to move above the insulator 133 when the tool gantry 101 is disengaged from the Y tray 104 and translated above the insulator 133, as shown in FIGS. 10A-10D.

Alternatively, or in addition, the 3D printer may employ an active X tray coupling mechanism. For example, as shown in FIGS. 15A–15B, the X tray coupling mechanism may include one or more linear actuators 111, such as push-type solenoids, configured to move a pin 116 along the Z direction. The X tray 103 may define keyhole slots 142 extending in the X direction, and each pin 116 may include a radial extension 147 at its end, configured for insertion into a corresponding opening 148 of a keyhole slot 142. The engagement process may begin by positioning the tool carriage 102 over the X tray 103 such that the pins 116 are axially aligned with their respective openings 148. The process may then include lowering the pins 116 into the openings 148, followed by translating the tool carriage 102 in a direction 194 along the X axis, advancing the pins 116 along their respective slots 142. Alternatively, the slots 142 may extend in the Y direction and the process may include moving the tool gantry 101 along the Y direction to advance the pins 116 along their respective slots 142. The process may further include lifting the pins 116 using the linear actuators 111, thereby vertically pulling the X tray 103 toward the tool carriage 102 to secure engagement.

In some embodiments, as shown in FIGS. 15A–15B, the tool carriage 102 may further include an electrical connector 144 configured to provide power or signal connectivity to one or more devices mounted on the X tray 103, such as blowers, leveling sensors, localized heaters, or the like. The X tray 103 may include a corresponding receptacle connector 143, vertically aligned with connector 144 in the engaged state, such that electrical contact is established when the X tray 103 is vertically pulled upward by the pins 116 during the engagement process. In some embodiments, the connectors 143 and 144 may be magnetic connectors.

Additionally, the X tray coupling mechanism may include a spring element that is energized during engagement. The spring element may further be configured to facilitate disengagement of the X tray 103—and optionally the electrical connectors 143 and 144—when the pins 116 are lowered.

Configurations of the present disclosure providing selective engagement of the carrier with the tool gantry enable substantial spatial and functional advantages over conventional permanently affixed insulator designs. For example, this configuration enables integration of auxiliary subsystems, such as purging stations 160, while also significantly reducing the volume required by dynamic insulators. As illustrated in FIG. 4, the 3D printer 100 includes a first Y tray 104L permanently coupled to a first tool gantry 101L and a second Y tray 104R selectively engageable with a second tool gantry 101R via the coupling mechanism 105. The permanently coupled Y tray 104L necessitates that a first Y insulator 133L occupies a larger space (volume 196), whereas a second Y insulator 133R, enabled by selective engagement, avoids occupying the corresponding volume (unoccupied volume 195), thereby contributing to a more compact overall printer design. Additionally or alternatively, the selective engagement may enable the tool gantry 101 to translate along the Y direction to positions outside a footprint of the Y tray 104 for purposes such as parking at a parking station 170, tool changing, purging at a purging station 160, and introduction of pre-fabricated objects via access windows 140, as described elsewhere in the present disclosure.

In some embodiments, such as those illustrated in FIGS. 12A–12E, the fabrication system may further include a carrier (e.g., the Y tray 104) shared between a first tool gantry 101L and a second tool gantry 101R, in which the first tool gantry 101L includes a first primary coupling mechanism 105L for selectively engaging the shared Y tray 104 to the first tool gantry 101L, and the second tool gantry 101R includes a second primary coupling mechanism 105R for selectively engaging the shared Y tray 104 to the second tool gantry 101R. In some such embodiments, the fabrication system may include a first auxiliary coupling mechanism 106L associated with the first tool gantry 101L and a second auxiliary coupling mechanism 106R associated with the second tool gantry 101R, the first and second auxiliary coupling mechanisms 106L, 106R being offset along the Y direction relative to the respective first and second primary coupling mechanisms 105L, 105R. The auxiliary coupling mechanisms may be configured to engage the shared Y tray 104 when the respective primary coupling mechanism is inaccessible due to a position of one of the first tool gantry 101L or the second tool gantry 101R along the Y direction. For example, as illustrated in FIGS. 12B and 12C, when movement of one tool gantry toward the Y tray 104 is obstructed by the other tool gantry, the auxiliary coupling mechanism of the first-mentioned tool gantry—being offset along the Y direction from the corresponding primary coupling mechanism—remains positioned to engage the Y tray 104 despite the obstruction.

The auxiliary coupling mechanism 106 may employ any of the configurations described above with respect to the primary coupling mechanism 105. For example, as illustrated in FIGS. 13A–13B, the auxiliary coupling mechanism 106 may comprise an electromagnet 115B mounted with an offset along the Y direction relative to the electromagnet 115A of the primary coupling mechanism 105, the electromagnet 115B being configured to engage the Y tray 104 by establishing magnetic coupling with a corresponding armature 145B that is coupled to or formed integrally with the Y tray 104. As another example, as illustrated in FIGS. 14A–14B, the auxiliary coupling mechanism 106 may comprise a push-type solenoid 112B offset along the Y direction relative to the push-type solenoid 112A of the primary coupling mechanism 105, the push solenoid 112B being configured to engage the Y tray 104 by extending a pin 113 through an opening 114B in the Y tray 104.

The build chamber 130 may include one or more openings, hereinafter referred to as access windows 140, formed by the insulating structures 132. An access window 140 may be configured to allow tools 110 to enter the build chamber 130 through the insulating structures 132, as shown in FIGS. 10A–10D and 11. In some embodiments, the access window 140 may be configured to permit passage of the tool 110 (or another item, e.g., a green body , a partially formed or processed workpiece) through the insulating structure 132 along a direction substantially parallel to the insulating structure 132, such as along the Y direction or the X direction. In such embodiments, the tool 110 is configured to enter the build chamber 130 through the access window 140 without being translated along a direction transverse to both the Y and X directions (e.g., along the Z direction) to a position above the insulating structures 132 prior to said entry. Such lateral entry of the tool 110 through the access window 140 may be enabled by the selective disengagement of the tool gantry 101 from the Y tray 104, which allows the tool gantry 101 to translate the tool 110 along the Y direction to a position at which the tool 110 is aligned with the access window 140 along the Y direction. Alternatively, or in addition, the access window 140 may be configured to allow entry of the bottom extension 136, as shown in FIGS. 10A–10D and 11. In further embodiments, the access window 140 may be configured to allow pre-fabricated objects to be introduced into the build chamber 130 using a pick-and-place gripper 110C, as illustrated in FIGS. 2–5. Such objects may be stored in a feeder 141 positioned outside the build chamber 130 and configured to advance the objects vertically or horizontally for pick-up by the gripper 110C, as shown in FIGS. 2–5.

In some embodiments, the access window 140 may include a cover 138 configured to seal or insulate the access window 140 when no object or tool is passing through it. The cover 138 may provide thermal, particulate, or atmospheric isolation, depending on the intended application. For example, the access window 140 may be covered by a deformable or rollable cover 138, as best shown in FIGS. 10A–10D. In other embodiments, the cover 138 may be implemented as an access panel, as shown in FIG. 11.

The access window 140 may further include an actuator 139 configured to open or close the cover 138. For instance, the actuator 139 may be a solenoid operatively coupled to the cover 138, as illustrated in FIGS. 12A–12C. In some embodiments, the cover 138 may be mechanically actuated by movement of the tool carriage 102. For example, as shown in FIG. 11, the cover 138 may be opened by contact with the bottom extension 136 as it moves through the access window 140. In other embodiments, the access window 140 may be uncovered, for instance, when environmental isolation is not required or when tool access needs to remain unobstructed.

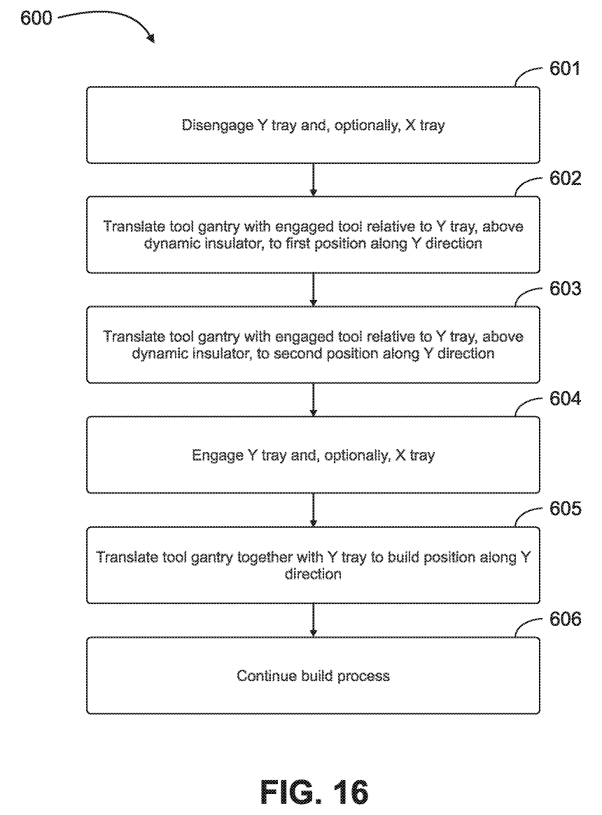

Referring now to FIG. 16, shown is a block diagram illustrating a method 600 of operating a fabrication system that includes a tool gantry 101, a carrier (e.g., Y tray 104), and a coupling mechanism 105 configured to selectively engage and disengage the carrier from the tool gantry 101. The method 600 may be further described with reference to FIGS. 10A–10D.

The method 600 includes 601 disengaging the coupling mechanism 105 such that the carrier is decoupled from the tool gantry 101, and optionally disengaging a second carrier (e.g., X tray 103) from the tool carriage 102. The method 600 further includes 602 translating the tool gantry 101, while carrying the tool 110 and while the coupling mechanism 105 is disengaged, along the Y direction to a first position along the Y direction, for example, to a position at which the tool gantry 101 is not aligned with the carrier along the Y direction, such as a position above the dynamic Y insulator 133 as best shown in FIGS. 10C–10D. The method 600 further includes 603 translating the tool gantry 101, while carrying the tool 110 and while the coupling mechanism 105 remains disengaged, along the Y direction toward the carrier to a second position along the Y direction. The method 600 further includes 604 engaging the coupling mechanism 105 such that the carrier is coupled to the tool gantry 101, and optionally engaging the second carrier (e.g., X tray 103) with the tool carriage 102. The method 600 further includes 605 translating the tool gantry 101 together with the carrier along the Y direction to a build position, and 606 continuing a build process by fabricating, using the tool 110 and while the coupling mechanism 105 is engaged, at least a portion of a workpiece.

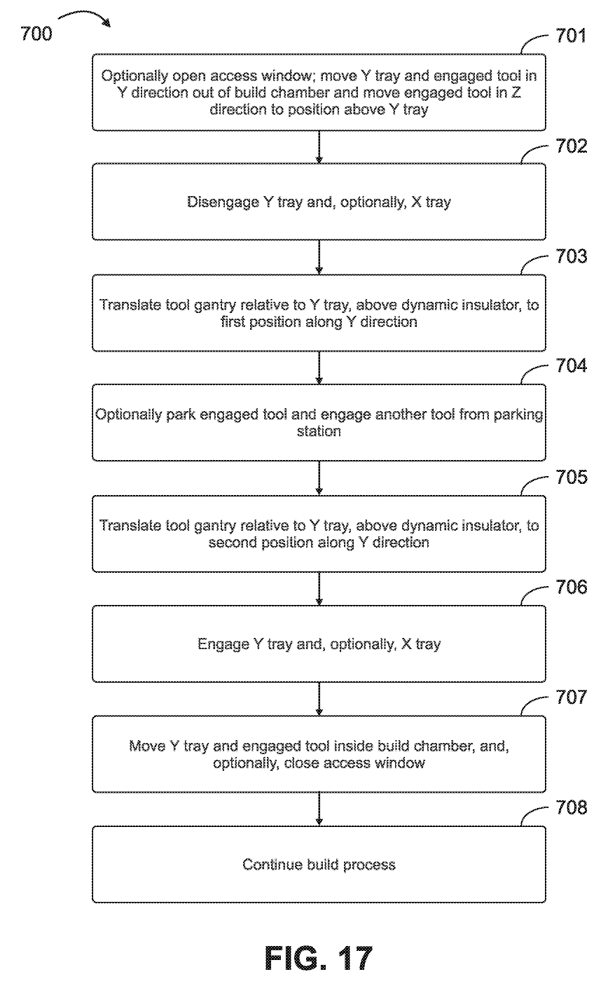

Referring now to FIG. 17, shown is a block diagram illustrating a method 700 of operating a fabrication system that includes a tool gantry 101, a carrier (e.g., Y tray 104), a coupling mechanism 105 configured to selectively engage and disengage the carrier from the tool gantry 101, a plurality of tools 110, and, optionally, an access window 140 including a cover 138. The method 700 may be further described with reference to FIGS. 10A–10D.

The method 700 includes , optionally, 701 opening the access window 140 and translating the tool gantry 101 along the Y direction such that the carrier and an engaged tool 110 exit the build chamber 130 through the access window 140, as illustrated in FIG. 10B. Alternatively, or in addition, 701 may include moving the engaged tool 110 along the Z direction to a position that provides clearance for subsequent translation of the tool gantry 101 relative to the carrier. The method 700 further includes 702 disengaging the coupling mechanism 105 such that the carrier is decoupled from the tool gantry 101, and optionally disengaging the second carrier (e.g., X tray 103) from the tool carriage 102, as illustrated in FIG. 10C. The method 700 further includes 703 translating the tool gantry 101, while the coupling mechanism 105 is disengaged, along the Y direction to a first position along the Y direction, for example, to a position at which the tool gantry 101 is not aligned with the carrier along the Y direction and is positioned relative to the dynamic Y insulator 133 or the dynamic Y insulator 134 to permit further translation of the tool gantry 101 along the Y direction, as illustrated in FIG. 10D.

The method 700 may further define a tool change procedure by further including, optionally, 704 parking the currently engaged tool 110 at a parking station 170 and engaging another tool 110 from a parking station 170. Operation 704 may include moving the tool carriage 102 along the X direction, and optionally along the Y or Z directions, to align the tool mount 108 with a parking station 170 for either parking the currently engaged tool 110 or retrieving another tool 110 from a corresponding parking station 170. In some embodiments, the parking station 170 is located at a position along the Y direction outside a footprint of the carrier defined by the Y direction and the X direction. In some embodiments, 704 may additionally or alternatively include purging material from a tool 110 at a purging station 160 disposed beneath the parking station 170, or exchanging the tool 110 at a tool change station with a different tool 110.

The method 700 further includes one or more of 705, 706, and 707, which correspond generally to a reversed sequence of the preceding 703, 702, and 701, as further illustrated in FIGS. 10D, 10C, and 10B. For example, 705 includes translating the tool gantry 101 along the Y direction, while the coupling mechanism 105 is disengaged, toward the carrier to a second position along the Y direction. Operation 706 includes engaging the coupling mechanism 105 such that the carrier is coupled to the tool gantry 101, and optionally engaging the second carrier (e.g., X tray 103) with the tool carriage 102. Operation 707 includes, optionally, translating the tool gantry 101 together with the carrier along the Y direction such that the tool gantry 101, the carrier, and the engaged tool 110 enter the build chamber 130 through the access window 140, and, optionally, closing the cover 138 of the access window 140. The method 700 further includes 708 continuing the build process by fabricating, using the tool 110 and while the coupling mechanism 105 is engaged, at least a portion of a workpiece.

In some embodiments, during the method 700, the tool gantry 101 is configured to pass above the carrier, such as above the Y tray 104, during one or more of 702, 703, 704, 705, or 706, as shown in FIGS. 3, 4, 6, and 10C–10D. Additionally or alternatively, during one or more of these operations, the tool gantry 101 is configured to translate along the Y direction to a position outside a footprint of the carrier defined by the Y direction and the X direction, thereby accessing a parking station 170, a tool change station, a purging station 160, or an access window 140, as described elsewhere in the present disclosure.

Referring now to FIGS. 12A–12E, the fabrication system may include a carrier (e.g., the Y tray 104) that is shared by a plurality of the tool gantries 101. For example, FIGS. 12A–12E illustrate an embodiment where the carrier is shared by two tool gantries 101L and 101R, meaning that the carrier is engaged with the tool gantry 101L and disengaged from the tool gantry 101R when the tool gantry 101L carries an active tool. Conversely, when the tool gantry 101R carries an active tool, the carrier is engaged with the tool gantry 101R and disengaged from the tool gantry 101L.

The fabrication system may include one or more auxiliary coupling mechanisms 106. Each auxiliary coupling mechanism 106 may be associated with a respective tool gantry 101 and may be configured to provide engagement of the carrier to the respective tool gantry 101 when the primary coupling mechanism 105 associated with that tool gantry 101 is inaccessible, for example, when the primary coupling mechanism 105 is blocked or rendered inaccessible due to a position of another tool gantry 101 along the Y direction. For example, as shown in FIGS. 12A–12E, the fabrication system may include a first auxiliary coupling mechanism 106L associated with the first tool gantry 101L and configured to engage the carrier with the first tool gantry 101L, and a second auxiliary coupling mechanism 106R associated with the second tool gantry 101R and configured to engage the carrier with the second tool gantry 101R.

For example, as shown in FIGS. 13A–13B, the auxiliary coupling mechanism 106 may include an electromagnet 115B mounted with an offset along the Y direction relative to the electromagnet 115A of the primary coupling mechanism 105. The electromagnet 115B is configured to engage the carrier by establishing magnetic coupling with a corresponding armature 145B that is either coupled to or formed integrally with the carrier. As another example, as shown in FIGS. 14A–14B, the auxiliary coupling mechanism 106 may include a push-type solenoid 112B, also offset along the Y direction relative to the push-type solenoid 112A of the primary coupling mechanism 105. The push solenoid 112B is configured to engage the carrier by extending its pin 113 through an opening 114 in the carrier.

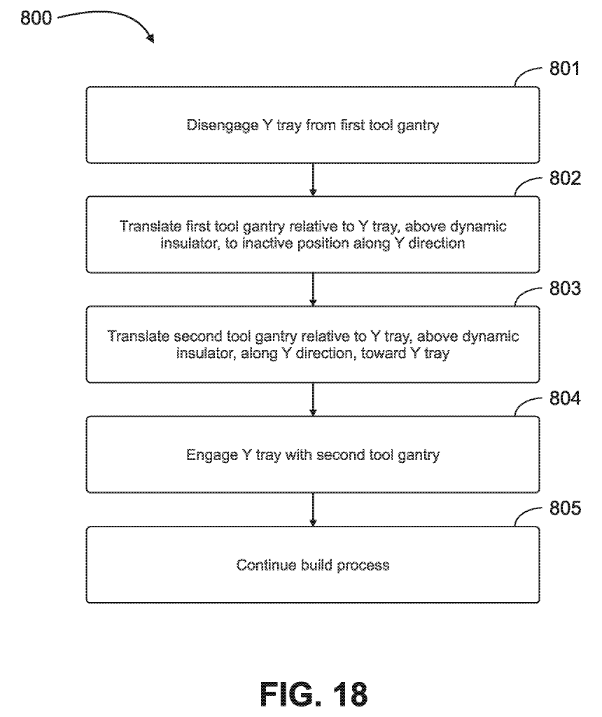

Referring now to FIG. 18, shown is a block diagram illustrating a method 800 of operating a fabrication system that includes a carrier (e.g., Y tray 104) shared between a first tool gantry 101L and a second tool gantry 101R, a first coupling mechanism 105L operable to selectively engage and disengage the carrier from the first tool gantry 101L, and a second coupling mechanism 105R operable to selectively engage and disengage the carrier from the second tool gantry 101R. The method 800 may be described with reference to FIGS. 12A–12E.

The method 800 includes 801 disengaging the first coupling mechanism 105L such that the carrier is decoupled from the first tool gantry 101L. The method 800 further includes 802 translating the first tool gantry 101L along the Y direction, while the first coupling mechanism 105L is disengaged, to an inactive position along the Y direction, for example, to a position at which the first tool gantry 101L is located away from the carrier such that the first tool gantry 101L does not obstruct subsequent movement of the second tool gantry 101R toward the carrier. In some embodiments, 802 may include translating the first tool gantry 101L along the Y direction to a parking position associated with a parking station 170 that is located outside a footprint of the carrier defined by the Y direction and the X direction. The method 800 further includes 803 translating the second tool gantry 101R along the Y direction, while the second coupling mechanism 105R is disengaged, toward the carrier. The method 800 further includes 804 engaging the second coupling mechanism 105R such that the carrier is coupled to the second tool gantry 101R. The method 800 further includes 805 continuing a build process by fabricating, using a tool 110 carried by the second tool gantry 101R and while the second coupling mechanism 105R is engaged, at least a portion of a workpiece.

In some embodiments, the method 800 may further include, prior to 801, fabricating at least another portion of the workpiece using a tool 110 carried by the first tool gantry 101L while the first coupling mechanism 105L is engaged, such that the workpiece is formed through cooperative operation of tools 110 carried by the first and second tool gantries 101L and 101R. Alternatively, or in addition, the method 800 may further include, while the second coupling mechanism 105R is engaged with the second tool gantry 101R, exchanging a tool 110 carried by the first tool gantry 101L for a different tool 110 at a parking station 170 or a tool change station, such that a tool change operation on the first tool gantry 101L may be performed in parallel with the fabrication operation performed by the second tool gantry 101R. Alternatively, or in addition, the method 800 may further include, while both the first coupling mechanism 105L and the second coupling mechanism 105R are disengaged from the carrier, retaining the carrier in position relative to the fabrication system by at least one of a limiter 117, a rail brake, or an independent linear drive coupled to the carrier.

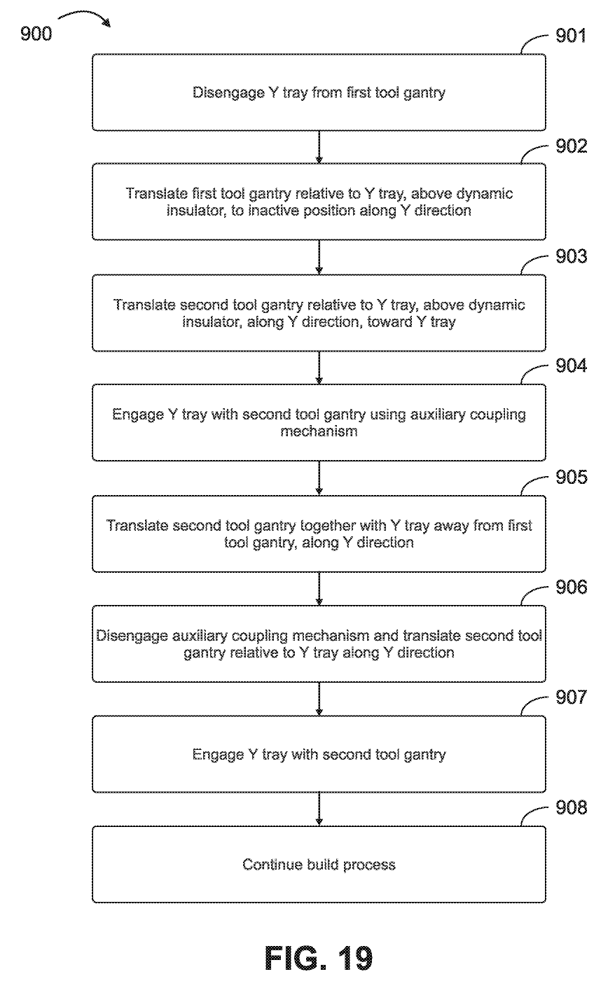

Referring now to FIG. 19, shown is a block diagram illustrating a method 900 of operating a fabrication system that includes a carrier (e.g., Y tray 104) shared between a first tool gantry 101L and a second tool gantry 101R, a first coupling mechanism 105L for selectively engaging the carrier to the first tool gantry 101L, a second coupling mechanism 105R for selectively engaging the carrier to the second tool gantry 101R, and at least one auxiliary coupling mechanism 106 offset along the Y direction relative to at least one of the first or second coupling mechanisms 105L, 105R. The method 900 may be described with reference to FIGS. 12A–12E.

The method 900 includes 901 disengaging the first coupling mechanism 105L such that the carrier is decoupled from the first tool gantry 101L. The method 900 further includes 902 translating the first tool gantry 101L along the Y direction, while the first coupling mechanism 105L is disengaged, to an inactive position along the Y direction. The method 900 further includes 903 translating the second tool gantry 101R along the Y direction toward the carrier.

The method 900 further includes 904 engaging the carrier with the second tool gantry 101R via an auxiliary coupling mechanism 106R associated with the second tool gantry 101R, as illustrated in FIG. 12C. The auxiliary coupling mechanism 106R is offset along the Y direction relative to the second coupling mechanism 105R associated with the second tool gantry 101R, such that the auxiliary coupling mechanism 106R is positioned to engage the carrier despite an obstruction that may otherwise prevent the second coupling mechanism 105R from engaging the carrier. For example, as shown in FIG. 12C, in the illustrated operational state, the second coupling mechanism 105R is unable to engage the carrier because movement of the second tool gantry 101R along the Y direction toward the carrier is obstructed by a position of the first tool gantry 101L along the Y direction; however, the auxiliary coupling mechanism 106R—being offset along the Y direction from the second coupling mechanism 105R—is positioned to engage the carrier despite the obstruction.

The method 900 further includes 905 translating the second tool gantry 101R together with the carrier along the Y direction away from the first tool gantry 101L, which provides clearance between the first tool gantry 101L and the carrier. The method 900 further includes 906 disengaging the auxiliary coupling mechanism 106R and translating the second tool gantry 101R along the Y direction relative to the carrier, and 907 engaging the second coupling mechanism 105R such that the carrier is coupled to the second tool gantry 101R via the second coupling mechanism 105R. The method 900 further includes 908 continuing the build process by fabricating, using a tool 110 carried by the second tool gantry 101R and while the second coupling mechanism 105R is engaged, at least a portion of a workpiece.

Alternatively, in some embodiments, the method 900 may include engaging the carrier with the second tool gantry 101R via the auxiliary coupling mechanism 106R without subsequently disengaging the auxiliary coupling mechanism 106R and re-engaging the second coupling mechanism 105R. In such embodiments, the workpiece may be fabricated with the carrier coupled to the second tool gantry 101R via the auxiliary coupling mechanism 106R rather than via the second coupling mechanism 105R.

In some embodiments, the parking station 170 may include an actuator configured to position the tool mount 109 along the Z direction. For example, in embodiments where the tool carriage is not equipped with the tool axis 107, the tool 110 may be lifted above the build chamber 130 along the Z direction by the actuator to achieve required vertical clearance, thereby allowing the carrier (e.g., Y tray 104) and, optionally, the second carrier (e.g., X tray 103) to continue its motion unobstructed.

In other embodiments, the parking station 170 may include an actuator configured to position the tool mount 109 along the Y direction. For instance, where the tool carriage 102 is unable to reach a static parking station 170 due to travel limits along the Y direction, the tool mount 109 may be configured to retract toward the tool carriage 102, and subsequently return to its initial position after securing the tool 110.

In further embodiments, one or more parking stations 170 may employ a common actuator or robotic arm configured to position a tool interface along the Y and X directions, and optionally the Z direction, to retrieve a tool 110 from the tool carriage 102 and selectively dock it with the appropriate parking station 170.

In some embodiments—such as those corresponding to 3D printers 100, 200, 300, 400, and 500—the 3D printer may include one or more purging stations 160, configured to receive and remove material discharged by the printhead during purging operations. The purging station 160 may include a receiver 161, a waste collection tank 162, and a conduit 163 fluidly connecting the receiver to the tank, best shown in FIGS. 4, 5 and 10A-10D. The 3D printer may further include a vacuum pump operatively coupled to the tank 162 and configured to generate negative pressure, such that purged material deposited into the receiver 161 is drawn through the conduit 163 and collected in the tank 162.

In some embodiments, a plurality of 3D printers—such as those deployed in a print farm—may be fluidly connected to a centralized vacuum pump configured to serve as a shared source of negative pressure for all purging stations 160. Optionally, the purging stations 160 of individual 3D printers may also be connected to a central waste reservoir, such that material from each 3D printer is drawn via a conduit into the shared reservoir for collection and disposal.

In some embodiments, the purging station 160 may be positioned beneath one or more parking stations 170, such that a printhead 110A may be purged after being parked. The receiver 161 may further be mounted for movement along the Z, Y or X directions by an actuator. For example, the receiver 161 may be configured to retract in the Y direction toward an active printhead 110A for in-process purging, and then return to its default position beneath the parking station 170 when the printhead 110A is no longer active.

In some embodiments, the receiver 161 may be movable along the Z direction to establish closer proximity to a nozzle 120 of the printhead 110A during purging operations, thereby improving suction efficiency. In certain embodiments, the receiver 161 may be configured to form a substantial seal against the nozzle 120 when lifted along the Z direction. Alternatively, or in addition, the tool 110 may be moved toward the receiver along the Z direction by actuation of the tool axis 107.

This purging configuration is particularly advantageous in fused granular fabrication (FGF) 3D printing, where pellet-based extruders frequently require purging to prevent thermal degradation of material and to maintain a consistent extrusion process. Purging is critical in sustaining print quality, particularly during material changes, idle periods, or extended print cycles. Additionally or alternatively, the positioning of the purging station 160 beneath the parking station 170 is enabled by the selective engagement of the carrier with the tool gantry 101, which allows the tool gantry 101 to translate along the Y direction to the parking station 170 at a position outside a footprint of the carrier, thereby providing vertical clearance beneath the parking station 170 for the purging station 160.

In some embodiments—such as those corresponding to 3D printers 100, 300, and 500—the 3D printer may include a subtractive tool 110B, such as a milling spindle, configured to perform material removal operations as part of a hybrid additive-subtractive manufacturing process. The subtractive tool 110B may be configured to interface with an automatic tool changer (ATC) system 151 for automated switching between different tool ends. In such embodiments, the ATC 151 may be located outside the build chamber 130, and, optionally below the Y insulator 133, as shown in FIG. 2. The ATC 151 may include a rotary carousel, linear magazine, or robotic mechanism configured to position and exchange tool end with the subtractive tool 110B in accordance with instructions from the control system.

### EXAMPLE SOLUTIONS

Some embodiments may implement one or more of the following solutions, listed in clause-format. The following clauses are supported and further described in the embodiments above and throughout this document.

Solution 1. A 3D printing system, comprising: a tool comprising a printhead; a tool gantry movable along the a first direction, the tool gantry being configured to carry the tool; a tool carriage on the tool gantry, the tool carriage being movable along the a second direction transverse to the first direction; a carrier; and a coupling component configured to selectively couple the carrier to the tool gantry, the coupling component being operable during a fabrication operation to selectively engage and disengage the carrier from the tool gantry, wherein: when the coupling component is engaged, the carrier is coupled to the tool gantry such that the carrier is movable along the first direction by movement of the tool gantry, and when the coupling component is disengaged, the carrier is decoupled from the tool gantry such that the tool gantry is movable along the first direction without imparting motion along the first direction to the carrier.

Solution 2. A fabrication system, comprising: a tool gantry movable along a first direction, the tool gantry being configured to carry a tool; a carrier movable along the first direction; and a coupling component configured to selectively couple the carrier to the tool gantry, the coupling component being operable during a fabrication operation to selectively engage and disengage the carrier from the tool gantry, wherein: when the coupling component is engaged, the carrier is movable along the first direction by movement of the tool gantry, and when the coupling component is disengaged, the tool gantry is movable along the first direction without imparting motion along the first direction to the carrier.

Solution 3. The fabrication system of any one or more solutions disclosed herein, comprising a tool carriage on the tool gantry, the tool carriage being movable along a second direction non-parallel to the first direction, the tool carriage being configured to carry the tool to move along the second direction.

Solution 4. The system of any one or more solutions disclosed herein, wherein the tool comprises at least one of a printhead, a melt blowing head, a subtractive tool, a milling spindle, a laser, an inspection tool, a metrology tool, or a pick-and-place gripper.

Solution 5. The system of any one or more solutions disclosed herein, wherein the carrier comprises, carries, or defines at least one feature selected from the group consisting of: (a) a partition extending along the second direction and configured to provide at least one of thermal isolation, debris containment or collection, airflow control, optical or radiation shielding, or process-zone isolation; (b) one or more process-support devices configured to monitor, support, or contribute to the fabrication operation performed by the tool; and (c) an access feature configured to permit selective passage of at least one of the tool, a workpiece, or a service line into or out of a build region of the system.

Solution 6. The system of any one or more solutions disclosed herein, wherein the partition comprises at least one of: (i) a dynamic partition coupled to the carrier and configured to expand and contract along the first direction in response to motion of the carrier; or (ii) an integrated partition forming part of the carrier and configured to permit selective access of the tool to the build region of the system.

Solution 7. The system of any one or more solutions disclosed herein, wherein the dynamic partition comprises at least one of a deformable structure, a rollable structure, or a telescopic structure.

Solution 8. The system of any one or more solutions disclosed herein, wherein the one or more process-support devices comprises at least one of: a sensor configured to monitor the fabrication operation; a localized heating element; a localized cooling element; an illumination element; a fan duct; an air curtain; a coolant or lubricant delivery element; an energy source configured to cure or melt deposited material; an atmosphere management element; a material guide; or an umbilical support.

Solution 9. The system of any one or more solutions disclosed herein, wherein the coupling component comprises an active coupling component including at least one of (i) an electromagnet and a corresponding armature, or (ii) a solenoid and a retractable pin.

Solution 10. The system of any one or more solutions disclosed herein, wherein the coupling component comprises a passive coupling component including at least one of a permanent magnet, a mechanical latch, or a friction-based engagement.

Solution 11. The system of any one or more solutions disclosed herein, comprising at least one of a limiter or a rail brake configured to retain the carrier in position when the coupling component is disengaged.

Solution 12. The system of any one or more solutions disclosed herein, comprising a parking station disposed outside a footprint of the carrier in a plane defined by the first direction and the second direction, wherein: the tool gantry is configured to translate along the first direction to the parking station when the coupling component is disengaged, and the parking station is configured to receive the tool at a position along a third direction transverse to the first direction and the second direction when the coupling component is disengaged.

Solution 13. The system of any one or more solutions disclosed herein, comprising a purging station disposed beneath the parking station, the purging station being configured to receive purged material from the tool.

Solution 14. The system of any one or more solutions disclosed herein, comprising a tool change station configured to exchange the tool with a different tool while the coupling component is disengaged.

Solution 15. The system of any one or more solutions disclosed herein, wherein the tool comprises a pellet-fed extruder.

Solution 16. The system of any one or more solutions disclosed herein, comprising a second tool gantry movable along the first direction, wherein: the carrier is shared between the tool gantry and the second tool gantry; and the system comprises a second coupling component offset along the first direction relative to the coupling component, the second coupling component being configured to selectively couple the carrier to the second tool gantry.

Solution 17. The system of any one or more solutions disclosed herein, comprising a second tool carriage on the second tool gantry, the second tool carriage being movable along the second direction.

Solution 18. The system of any one or more solutions disclosed herein, wherein the tool carriage is a first tool carriage, the system comprising a second carrier movable along the second direction, wherein the second carrier is configured to selectively engage the first or second tool carriage.

Solution 19. The system of any one or more solutions disclosed herein, wherein the second carrier comprises a bottom extension extending toward a build region of the system.

Solution 20. The system of any one or more solutions disclosed herein, wherein the bottom extension comprises one of a fan duct or a dust shoe configured to remove debris generated by an operation of the tool.

Solution 21. The system of any one or more solutions disclosed herein, comprising one or more access windows in a wall enclosing at least a portion of a build region, the one or more access windows being configured to permit lateral passage of the tool or another item through the wall along a direction substantially parallel to the first direction or the second direction.

Solution 22. The system of any one or more solutions disclosed herein, comprising a pick-and-place gripper carried by the tool gantry, the pick-and-place gripper being configured to move the another item through the one or more access windows.

Solution 23. A method of operating a fabrication system, the fabrication system comprising a tool gantry movable along a first direction and configured to carry a tool, a carrier movable along the first direction, and a coupling component operable to selectively engage and disengage the carrier from the tool gantry, the method comprising: disengaging the coupling component such that the carrier is decoupled from the tool gantry; translating the tool gantry along the first direction, while the coupling component is disengaged, thereby changing a relative position of the tool gantry with respect to the carrier along the first direction; translating the tool gantry along the first direction, while the coupling component is disengaged, toward the carrier; engaging the coupling component such that the carrier is coupled to the tool gantry; and fabricating, using the tool and while the coupling component is engaged, at least a portion of a workpiece.

Solution 24. The method of any one or more solutions disclosed herein, comprising, while the coupling component is disengaged, parking the tool at a parking station, wherein the parking station is located outside a footprint of the carrier defined by the first direction and a second direction transverse to the first direction.

Solution 25. The method of any one or more solutions disclosed herein, comprising, while the coupling component is disengaged and prior to the fabricating operation, purging material from the tool at a purging station disposed beneath the parking station.

Solution 26. The method of any one or more solutions disclosed herein, comprising, while the coupling component is disengaged, exchanging the tool carried by the tool gantry for a different tool, wherein the fabricating operation is further performed using the different tool.

Solution 27. The method of any one or more solutions disclosed herein, comprising, while the coupling component is disengaged, retaining the carrier in position relative to a frame of the fabrication system by at least one of a limiter, a rail brake, or an independent linear drive coupled to the carrier.

Solution 28. The method of any one or more solutions disclosed herein, comprising translating the tool or another item through an access window in a wall enclosing at least a portion of a build region to move the tool or the another item through the access window.

Solution 29. A method of operating a fabrication system, the fabrication system comprising a first tool gantry configured to carry a first tool and a second tool gantry configured to carry a second tool, each of the first tool gantry and the second tool gantry being movable along a first direction, a carrier movable along the first direction and shared by the first tool gantry and the second tool gantry, a first coupling component operable to selectively engage and disengage the carrier from the first tool gantry, and a second coupling component operable to selectively engage and disengage the carrier from the second tool gantry, the method comprising: disengaging the first coupling component such that the carrier is decoupled from the first tool gantry; translating the first tool gantry along the first direction away from the carrier to a parking position, while the first coupling component is disengaged; translating the second tool gantry along the first direction toward the carrier, while the second coupling component is disengaged; engaging the second coupling component such that the carrier is coupled to the second tool gantry; and fabricating, using the second tool and while the second coupling component is engaged, at least a portion of a workpiece.

Solution 30. The method of any one or more solutions disclosed herein, comprising, prior to disengaging the first coupling component, fabricating at least another portion of the workpiece using the first tool while the first coupling component is engaged.

Solution 31. The method of any one or more solutions disclosed herein, wherein: the first coupling component is offset along the first direction from the second coupling component, and engaging the second coupling component comprises engaging the second coupling component with the carrier while the first tool gantry is positioned between the second tool gantry and the parking position along the first direction.

Solution 32. The method of any one or more solutions disclosed herein, wherein the parking position is located outside a footprint of the carrier in a plane defined by the first direction and a second direction non-parallel to the first direction.

Solution 33. The method of any one or more solutions disclosed herein, comprising, while both the first coupling component and the second coupling component are disengaged from the carrier, retaining the carrier in position by at least one of a limiter, a rail brake, or an independent linear drive coupled to the carrier.

Solution 34. The method of any one or more solutions disclosed herein, comprising, while the second tool gantry is engaged with the carrier via the second coupling component, exchanging the first tool carried by the first tool gantry for a different tool.

Solution 35. The method of any one or more solutions disclosed herein, comprising, while the first tool gantry is at the parking position, purging material from the first tool at a purging station disposed beneath the parking position.

Solution 36. The method of any one or more solutions disclosed herein, comprising, while the second coupling component is engaged, translating the second tool gantry and the carrier together along the first direction during the fabricating operation.

It will be apparent to those having skill in the art that changes may be made to the details of the above-described embodiments without departing from the underlying principles of the present disclosure. In some cases, well-known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A 3D printing system, comprising:
a tool comprising a printhead;
a tool gantry movable along a first direction, the tool gantry being configured to carry the tool;
a tool carriage on the tool gantry, the tool carriage being movable along a second direction transverse to the first direction;
a carrier; and
a coupling component configured to selectively couple the carrier to the tool gantry, the coupling component being operable during a fabrication operation to selectively engage and disengage the carrier from the tool gantry, wherein:
when the coupling component is engaged, the carrier is coupled to the tool gantry such that the carrier is movable along the first direction by movement of the tool gantry, and
when the coupling component is disengaged, the carrier is decoupled from the tool gantry such that the tool gantry is movable along the first direction without imparting motion along the first direction to the carrier.

2. A fabrication system, comprising:
a tool gantry movable along a first direction, the tool gantry being configured to carry a tool;
a carrier movable along the first direction; and
a coupling component configured to selectively couple the carrier to the tool gantry, the coupling component being operable during a fabrication operation to selectively engage and disengage the carrier from the tool gantry, wherein:
when the coupling component is engaged, the carrier is movable along the first direction by movement of the tool gantry, and
when the coupling component is disengaged, the tool gantry is movable along the first direction without imparting motion along the first direction to the carrier.

3. The fabrication system of claim 2, wherein the tool comprises at least one of a printhead, a melt blowing head, a subtractive tool, a milling spindle, a laser, an inspection tool, a metrology tool, or a pick-and-place gripper.

4. The fabrication system of claim 2, comprising a tool carriage on the tool gantry, the tool carriage being movable along a second direction non-parallel to the first direction, the tool carriage being configured to carry the tool to move along the second direction.

5. The fabrication system of claim 4, wherein the carrier comprises, carries, or defines at least one feature selected from the group consisting of:
(a) a partition extending along the second direction and configured to provide at least one of thermal isolation, debris containment or collection, airflow control, optical or radiation shielding, or process-zone isolation;
(b) one or more process-support devices configured to monitor, support, or contribute to the fabrication operation performed by the tool; and
(c) an access feature configured to permit selective passage of at least one of the tool, a workpiece, or a service line into or out of a build region of the system.

6. The fabrication system of claim 5, wherein the partition comprises at least one of: (i) a dynamic partition coupled to the carrier and configured to expand and contract along the first direction in response to motion of the carrier; or (ii) an integrated partition forming part of the carrier and configured to permit selective access of the tool to the build region of the system.

7. The fabrication system of claim 6, wherein the dynamic partition comprises at least one of a deformable structure, a rollable structure, or a telescopic structure.

8. The fabrication system of claim 5, wherein the one or more process-support devices comprises at least one of: a sensor configured to monitor the fabrication operation; a localized heating element; a localized cooling element; an illumination element; a fan duct; an air curtain; a coolant or lubricant delivery element; an energy source configured to cure or melt deposited material; an atmosphere management element; a material guide; or an umbilical support.

9. The fabrication system of claim 2, wherein the coupling component comprises an active coupling component including at least one of (i) an electromagnet and a corresponding armature, or (ii) a solenoid and a retractable pin.

10. The fabrication system of claim 2, wherein the coupling component comprises a passive coupling component including at least one of a permanent magnet, a mechanical latch, or a friction-based engagement.

11. The fabrication system of claim 4, comprising a parking station disposed outside a footprint of the carrier in a plane defined by the first direction and the second direction, wherein:
the tool gantry is configured to translate along the first direction to the parking station when the coupling component is disengaged, and
the parking station is configured to receive the tool at a position along a third direction transverse to the first direction and a second direction when the coupling component is disengaged, the second direction being non-parallel to the first direction.

12. The fabrication system of claim 11, comprising a purging station disposed beneath the parking station, the purging station being configured to receive purged material from the tool.

13. The fabrication system of claim 2, comprising a tool change station configured to exchange the tool with a different tool while the coupling component is disengaged.

14. The fabrication system of claim 2, wherein the tool comprises a pellet-fed extruder.

15. The fabrication system of claim 2, comprising a second tool gantry movable along the first direction, wherein:
the carrier is shared between the tool gantry and the second tool gantry; and
the system comprises a second coupling component offset along the first direction relative to the coupling component, the second coupling component being configured to selectively couple the carrier to the second tool gantry.

16. The fabrication system of claim 15, comprising a second tool carriage on the second tool gantry, the second tool carriage being movable along the second direction.

17. The fabrication system of claim 2, comprising one or more access windows in a wall enclosing at least a portion of a build region, the one or more access windows being configured to permit lateral passage of the tool or another item through the wall along a direction substantially parallel to the first direction or a second direction, the second direction being non-parallel to the first direction.

18. A method of operating a fabrication system, the fabrication system comprising a tool gantry movable along a first direction and configured to carry a tool, a carrier movable along the first direction, and a coupling component operable to selectively engage and disengage the carrier from the tool gantry, the method comprising:
disengaging the coupling component such that the carrier is decoupled from the tool gantry;
translating the tool gantry along the first direction, while the coupling component is disengaged, thereby changing a relative position of the tool gantry with respect to the carrier along the first direction;
translating the tool gantry along the first direction, while the coupling component is disengaged, toward the carrier;
engaging the coupling component such that the carrier is coupled to the tool gantry; and
fabricating, using the tool and while the coupling component is engaged, at least a portion of a workpiece.

19. The method of claim 18, comprising, while the coupling component is disengaged, parking the tool at a parking station, wherein the parking station is located outside a footprint of the carrier defined by the first direction and a second direction transverse to the first direction.

20. The method of claim 19, comprising, while the coupling component is disengaged and prior to the fabricating operation, purging material from the tool at a purging station disposed beneath the parking station.
